(19) United States
(12) Patent Application Publication
(10) Pub. No.: US 2016/0299376 A1
(43) Pub. Date: Oct. 13, 2016

(54) LIQUID CRYSTAL DISPLAY DEVICE, RADIATION-SENSITIVE RESIN COMPOSITION, INTERLAYER INSULATING FILM, METHOD FOR PRODUCING INTERLAYER INSULATING FILM, AND METHOD FOR MANUFACTURING LIQUID CRYSTAL DISPLAY DEVICE

(71) Applicant: JSR CORPORATION, TOKYO (JP)

(72) Inventors: SATORU ISHIKAWA, TOKYO (JP); HIROKI KUSUMOTO, TOKYO (JP)

(73) Assignee: JSR CORPORATION, TOKYO (JP)

(21) Appl. No.: 15/093,742

(22) Filed: Apr. 8, 2016

(30) Foreign Application Priority Data
Apr. 9, 2015 (JP) 2015-080271

(51) Int. Cl. G02F 1/1333; G02F 1/1368; G02F 1/1339; G02F 1/1343; G02F 1/1335; G02F 1/1337

(52) U.S. Cl. CPC G02F 1/133345; G02F 1/133512; G02F 1/133514; G02F 1/133711; G02F 1/1339; G02F 1/134309; G02F 1/13439; G02F 1/1368; G02F 2001/133357; G02F 2001/133742; G02F 2201/123; G02F 2201/121

(57) ABSTRACT

A liquid crystal display device 1 includes an array substrate 15 and a color filter substrate 90 paired with and disposed facing each other, a liquid crystal layer 10 formed from a polymerizable liquid crystal composition and disposed between the array substrate 15 and the color filter substrate 90, and an interlayer insulating film 52 laminated on a side of the array substrate 15 closer to the liquid crystal layer 10. The interlayer insulating film 52 is produced from a radiation-sensitive resin composition that contains [A] a polymer and [B] a photosensitizer, and has a transmittance of 70% or higher for light having a wavelength of 310 nm at a film thickness of 2 μm.

### CROSS-REFERENCE TO RELATED APPLICATION

This application claims the priority benefits of Japanese patent application no. 2015-080271, filed on Apr. 9, 2015. The entirety of the above-mentioned patent application is hereby incorporated by reference herein and made a part of this specification.

### FIELD OF THE INVENTION

The invention relates to a liquid crystal display device, a radiation-sensitive resin composition, an interlayer insulating film, a method for producing an interlayer insulating film, and a method for manufacturing a liquid crystal display device.

### DESCRIPTION OF THE RELATED ART

A liquid crystal display device is constructed by, e.g., sandwiching a liquid crystal between a pair of substrates such as glass substrates or the like. On surfaces of the pair of substrates, an alignment film can be provided as a liquid crystal alignment layer that controls alignment of the liquid crystal. Liquid crystal display devices function as a fine shutter for light radiating from a light source, such as backlight or external light, etc., and partially transmit the light or block the light so as to perform displaying. Liquid crystal display devices have excellent features such as thin profile, light weight, etc.

At their initial stage of development, liquid crystal display devices were utilized as display devices of calculators or clocks that center on character display, etc. Then, development of a simple matrix made dot matrix display easier, and the application expanded to display devices of laptop computers, etc. Furthermore, due to development of an active matrix type, good image quality excelling in contrast ratio or response performance can be realized, and challenges such as improvement in fineness, colorization and widening of viewing angle, etc. were also overcome, so that the application expanded to for use in monitors of desktop computers, etc. Recently, a wider viewing angle or faster response of liquid crystals or enhancement in display quality, etc. have been realized, leading to utilization of liquid crystal display devices as display devices for large, thin televisions.

Liquid crystal display devices are known to have various liquid crystal modes differing in initial alignment state or in alignment change action of liquid crystals. The liquid crystal modes include, e.g., TN (twisted nematic), STN (super twisted nematic), IPS (in-planes switching), VA (vertical alignment), FFS (fringe field switching) and OCB (optically compensated birefringence), etc.

Among the above liquid crystal modes, e.g., the VA mode is a liquid crystal mode in which the liquid crystal sandwiched between the pair of substrates is aligned perpendicular or substantially perpendicular to the substrates, and is one of the modes that have received attention in recent years due to having a wide viewing angle, a high response speed and a high contrast ratio. In VA-mode liquid crystal display devices, as an example thereof, a multi-domain vertical alignment (MVA) mode is being actively developed.

In an MVA-mode liquid crystal display device, in addition to the alignment film, an alignment controlling structure that controls an alignment direction of liquid crystals is used, and a plurality of regions (domains) in which liquid crystals have different alignment directions from each other are provided in one pixel. That is, the MVA-mode liquid crystal display device realizes a multi-domain pixel so as to realize a wider viewing angle property.

As for VA-mode (including MVA-mode) liquid crystal display devices, as an effective technique for manufacturing the same, a polymer sustained alignment (PSA) technique is being developed. In the PSA technique, a polymerizable compound (polymerizable component) such as a monomer, an oligomer or the like is mixed in a liquid crystal, so as to compose a liquid crystal layer by a polymerizable liquid crystal composition having photopolymerizability or thermal polymerizability. Then, there is a method (e.g., see Patent Document 1) in which a voltage is applied to the liquid crystal layer to bring the liquid crystal into a tilt-aligned state, and the polymerizable component is subsequently polymerized while the liquid crystal remains tilted, so that a polymer that has memorized a direction in which the liquid crystal is tilted due to the voltage application is provided on the substrates that sandwich the liquid crystal layer.

In the VA-mode liquid crystal display devices, by use of the PSA technique, it becomes possible to realize uniform tilting of liquid crystals in a pixel and to enhance the response speed. In the MVA-mode liquid crystal display device as an example thereof, the desired multi-domain pixel is further realized with high precision, and the wider viewing angle property can be realized.

For liquid crystal display devices having various modes as described above, in recent years, it has further been desired to improve image quality by achieving higher display definition or enhancing brightness, etc. For that reason, a technique is being actively developed for realizing higher display quality by applying the aforementioned liquid crystal modes to a liquid crystal display device of active matrix type, and further improving the device structure to be more suitably adapted to each liquid crystal mode.

For example, in the liquid crystal display device of active matrix type, a gate wiring and a signal wiring are arranged in a lattice on one of the pair of substrates sandwiching the liquid crystal, wherein a switching element such as a thin-film transistor (TFT) or the like is provided at an intersection between the gate wiring and the signal wiring, so as to form an array substrate. On the array substrate, a pixel electrode is disposed in a region surrounded by the gate wiring and the signal wiring, and a pixel as a display unit is composed of this pixel electrode.

In a liquid crystal display device, when higher image quality is to be realized by enhancing brightness, it is effective to make the pixel electrode larger. The same also applies to the liquid crystal display device of active matrix type, wherein by increasing the area of the pixel electrode as much as possible to improve an aperture ratio, the brightness can be increased. Hence, e.g., in Patent Document 2, a technique is disclosed of overlapping the pixel electrode with the gate wiring or the signal wiring to improve the aperture ratio. That is, in Patent Document 2, a liquid crystal display device is disclosed to have an insulating film composed of a thick-film organic material provided between a pixel electrode and a wiring on an array substrate, so as to be capable of improving an aperture ratio while suppressing an increase in coupling capacitance between the pixel electrode and the wiring. In Patent Document 3, a resin composition suitable for forming an insulating film is disclosed.

### PRIOR-ART DOCUMENTS

### Patent Documents

[Patent Document 1] JP 2003-149647

[Patent Document 2] JP 2001-264798

[Patent Document 3] JP 2004-264623

### SUMMARY OF THE INVENTION

### Problems to be Solved

However, as in the liquid crystal display device described in Patent Document 2, when an interlayer insulating film composed of an organic material is provided between the wiring and the pixel electrode of the array substrate, bubbling caused by the interlayer insulating film may become a problem. That is, in a pixel region of the liquid crystal display device where a plurality of pixels are disposed to perform displaying, gases or bubbles occur to give rise to bubbling, and a defective product may be produced as a result.

Such occurrence of the bubbling defect in the liquid crystal display device becomes a particularly noticeable phenomenon in the aforementioned VA-mode liquid crystal display device using the PSA technique.

As described above, in the VA-mode liquid crystal display device using the PSA technique, when the polymerizable liquid crystal composition that composes the liquid crystal layer has photopolymerizability, by irradiation with light such as an ultraviolet ray or the like, for example, the polymerizable component of the liquid crystal layer sandwiched by the array substrate is polymerized. In that case, by irradiation with an ultraviolet ray for polymerizing the polymerizable component, reaction of an unreacted component in the interlayer insulating film of the array substrate or photodecomposition reaction of the organic material that composes the interlayer insulating film occurs, and components having a low molecular weight are accordingly formed. It is understood that these low molecular components normally remain inside or on a surface of the interlayer insulating film by adsorption or the like, but their desorption is accelerated when the liquid crystal display device receives an impact, or the like, and they are formed into bubbles to appear in the pixel region.

In liquid crystal display devices, even those other than the VA-mode liquid crystal display device using the PSA technique, e.g., the array substrate is sometimes irradiated with light in a sealing step of sealing the liquid crystal layer between the pair of substrates, etc. In addition, due to the use after production, light is received from the outside and the low molecular components gradually form in the interlayer insulating film. The low molecular components accumulate, which may cause a defect by bubbling during the use.

Accordingly, in the liquid crystal display device, when the interlayer insulating film composed of an organic material is provided in the array substrate, application of a technique effective in suppressing the bubbling is desired.

The invention is made in view of the problems as described above. That is, a purpose of the invention is to provide a liquid crystal display device having an interlayer insulating film in which bubbling is easily suppressed.

A purpose of the invention is to provide a radiation-sensitive resin composition that forms an interlayer insulating film of a liquid crystal display device in which bubbling is easily suppressed.

A purpose of the invention is to provide an interlayer insulating film of a liquid crystal display device in which bubbling is easily suppressed.

A purpose of the invention is to provide a method for producing an interlayer insulating film that forms an interlayer insulating film of a liquid crystal display device in which bubbling is easily suppressed.

A purpose of the invention is to provide a method for manufacturing a liquid crystal display device having an interlayer insulating film in which bubbling is easily suppressed.

### Means for Solving the Problems

A first aspect of the invention relates to a liquid crystal display device characterized by having a pair of substrates disposed facing each other,
a liquid crystal layer formed from a polymerizable liquid crystal composition and disposed between the substrates, and
an interlayer insulating film laminated on a side of at least one of the substrates closer to the liquid crystal layer, wherein
the interlayer insulating film has a transmittance of 70% or higher for light having a wavelength of 310 nm at a film thickness of 2 μm.

In the first aspect of the invention, it is preferred that the film thickness of the interlayer insulating film be 1 μm or more and 5 μm or less, i.e., 1 μm to 5 μm.

In the first aspect of the invention, it is preferred that the substrate have a pixel electrode, and that the substrate, the interlayer insulating film and the pixel electrode be provided in this order.

In the first aspect of the invention, it is preferred that a liquid crystal alignment layer having a vertical alignment property be provided on a surface of the side of the substrate closer to the liquid crystal layer, so as to constitute a vertical alignment (VA) mode liquid crystal display device.

In the first aspect of the invention, it is preferred that the interlayer insulating film be formed using a radiation-sensitive resin composition containing [A] a polymer and [B] a photosensitizer.

In the first aspect of the invention, it is preferred that the polymerizable liquid crystal composition have photopolymerizability or thermal polymerizability.

A second aspect of the invention relates to a radiation-sensitive resin composition characterized by containing
[A] a polymer, and
[B] a photosensitizer, and
   by being used for forming the interlayer insulating film of the liquid crystal display device of the first aspect of the invention.

In the second aspect of the invention, it is preferred that the [A] polymer have at least one group selected from the group consisting of an epoxy group, a (meth)acryloyl group and a vinyl group.

In the second aspect of the invention, it is preferred that the [B] photosensitizer be at least one selected from the group consisting of a photo-radical polymerization initiator, a photoacid generator and a photobase generator.

A third aspect of the invention relates to an interlayer insulating film, characterized by being formed using the radiation-sensitive resin composition of the second aspect of the invention, by having a transmittance of 70% or higher for light having a wavelength of 310 nm at a film thickness of 2 μm, and by being used in a liquid crystal display device.

A fourth aspect of the invention relates to a method for producing an interlayer insulating film, characterized by including:
[1] a step of forming a coating film of the radiation-sensitive resin composition of the second aspect of the invention on a substrate;
[2] a step of irradiating at least a portion of the coating film formed in step [1] with radiation;
[3] a step of developing the coating film irradiated with the radiation in step [2]; and
[4] a step of heating the coating film developed in step [3], wherein
   the method produces an interlayer insulating film of a liquid crystal display device, the interlayer insulating film having a transmittance of 70% or higher for light having a wavelength of 310 nm at a film thickness of 2 μm.

A fifth aspect of the invention relates to a method for manufacturing a liquid crystal display device, characterized by including
a step of irradiating light onto a polymerizable liquid crystal composition sandwiched between a pair of substrates while a voltage is applied to the polymerizable liquid crystal composition, wherein
at least one of the pair of substrates has an interlayer insulating film produced by the method for producing an interlayer insulating film of the fourth aspect of the invention.

### Effects of the Invention

According to the first aspect of the invention, a liquid crystal display device is provided having an interlayer insulating film in which bubbling is easily suppressed.

According to the second aspect of the invention, a radiation-sensitive resin composition is provided that forms an interlayer insulating film of a liquid crystal display device in which bubbling is easily suppressed.

According to the third aspect of the invention, an interlayer insulating film of a liquid crystal display device is provided in which bubbling is easily suppressed.

According to the fourth aspect of the invention, a method for producing an interlayer insulating film is provided that forms an interlayer insulating film of a liquid crystal display device in which bubbling is easily suppressed.

According to the fifth aspect of the invention, a method for manufacturing a liquid crystal display device is provided, the liquid crystal display device having an interlayer insulating film in which bubbling is easily suppressed.

### BRIEF DESCRIPTION OF THE DRAWINGS

FIG. 1 is a schematic cross-sectional diagram of a pixel region of a liquid crystal display device as an example of the first embodiment of the invention.

FIG. 2 is a schematic cross-sectional diagram explaining another example of a TFT that constitutes an array substrate of the liquid crystal display device of the first embodiment of the invention.

### DESCRIPTION OF THE EMBODIMENTS

The embodiments of the invention are hereinafter explained by use of proper drawings.

Moreover, in the invention, the “radiation” irradiated during exposure includes visible rays, ultraviolet rays, far ultraviolet rays, X-rays and charged particle beams, etc.

### First Embodiment

### <Liquid Crystal Display Device>

A liquid crystal display device of the first embodiment of the invention is a liquid crystal display device having a pair of substrates disposed facing each other, a liquid crystal layer disposed sandwiched between the pair of substrates, and an interlayer insulating film disposed on a side of at least one of the pair of substrates closer to the liquid crystal layer and having a transmittance of 70% or higher for light having a wavelength of 310 nm at a film thickness of 2 μm. In the liquid crystal display device of the first embodiment of the invention, the interlayer insulating film may be a later-described interlayer insulating film of the third embodiment of the invention. The interlayer insulating film can be produced using a later-described radiation-sensitive resin composition of the second embodiment of the invention in accordance with a method for producing an interlayer insulating film of the fourth embodiment of the invention. That is, the liquid crystal display device of the first embodiment of the invention can be manufactured using an interlayer insulating film formed by the later-described method for producing an interlayer insulating film of the fourth embodiment of the invention.

Accordingly, the liquid crystal display device of the first embodiment of the invention has, on the substrates sandwiching the liquid crystal layer, the interlayer insulating film along with a pixel electrode and so on. Hence, as described above, the liquid crystal display device of the present embodiment is capable of realizing high-luminance display by having a higher pixel aperture ratio. Furthermore, the interlayer insulating film has higher ultraviolet transmission properties as compared to the prior art, particularly exhibiting a high transmittance with respect to light having a wavelength of 310 nm. That is, in the liquid crystal display device of the first embodiment of the invention, the transmittance of the interlayer insulating film for light having a wavelength of 310 nm is 70% or higher as described above in terms of a film thickness of 2 μm.

As a result, in the liquid crystal display device of the present embodiment, reaction of the interlayer insulating film caused by light, particularly the reaction caused by the more harmful light having a wavelength of 310 nm, can be reduced. In the liquid crystal display device of the present embodiment, a defect that the interlayer insulating film undergoes a photoreaction and generates a low molecular component to form bubbles in a pixel region can be reduced. That is, the liquid crystal display device of the present embodiment has, on the substrates sandwiching the liquid crystal layer, the interlayer insulating film along with the pixel electrode and so on. Meanwhile, the interlayer insulating film is an interlayer insulating film in which bubbling is easily suppressed, and the bubbling defect conventionally regarded as a problem can be reduced.

In the liquid crystal display device of the first embodiment of the invention, the liquid crystal mode can be selected from liquid crystal modes such as TN (twisted nematic), STN (super twisted nematic), IPS (in-planes switching), VA (vertical alignment), FFS (fringe field switching) and OCB (optically compensated birefringence), etc.

The liquid crystal display device of the first embodiment of the invention is preferably a liquid crystal display device of active matrix type so that the interlayer insulating film in which bubbling is easily suppressed effectively contributes to an improvement in display quality by increasing the pixel aperture ratio.

In addition, the liquid crystal display device of the first embodiment of the invention is preferably a VA-mode liquid crystal display device of active matrix type using a PSA technique so that effectiveness of the interlayer insulating film in which bubbling is easily suppressed becomes more noticeable. This VA-mode liquid crystal display device also includes an MVA mode.

In that case, in the liquid crystal display device of the first embodiment of the invention, the liquid crystal layer disposed sandwiched between the pair of substrates disposed facing each other is formed from a polymerizable liquid crystal composition containing a polymerizable component. After the liquid crystal layer is sealed between the pair of substrates, a voltage is applied thereto and the liquid crystal forms a tilt-aligned state. Then, while the voltage is applied, polymerization of the polymerizable component is performed, and a polymer that has memorized the direction in which the liquid crystal is tilted due to the voltage application can be provided on the substrates.

That is, in a method for manufacturing the liquid crystal display device of the first embodiment of the invention, a step is sometimes included of, while a voltage is applied to the polymerizable liquid crystal composition sandwiched between the pair of substrates, irradiating light such as UV light or the like thereon, or performing heating thereof, so as to polymerize the polymerizable component of the polymerizable liquid crystal composition. Even so, at least one of the pair of substrates is configured to have an interlayer insulating film produced by the later-described method for producing an interlayer insulating film of the fourth embodiment of the invention. The interlayer insulating film is the aforementioned interlayer insulating film in which bubbling is easily suppressed, and even if the polymerizable component of the polymerizable liquid crystal composition is photopolymerized, the phenomenon that the interlayer insulating film undergoes a photoreaction and generates a low molecular component can be reduced.

As a result, the liquid crystal display device of the first embodiment of the invention has a fast response speed, a high contrast ratio and a wider viewing angle so as to realize higher image quality, and furthermore, reduces bubbling so as to realize high reliability.

Hereinafter, as an example of the liquid crystal display device of the first embodiment of the invention, a VA-mode liquid crystal display device of active matrix type using the PSA technique is explained.

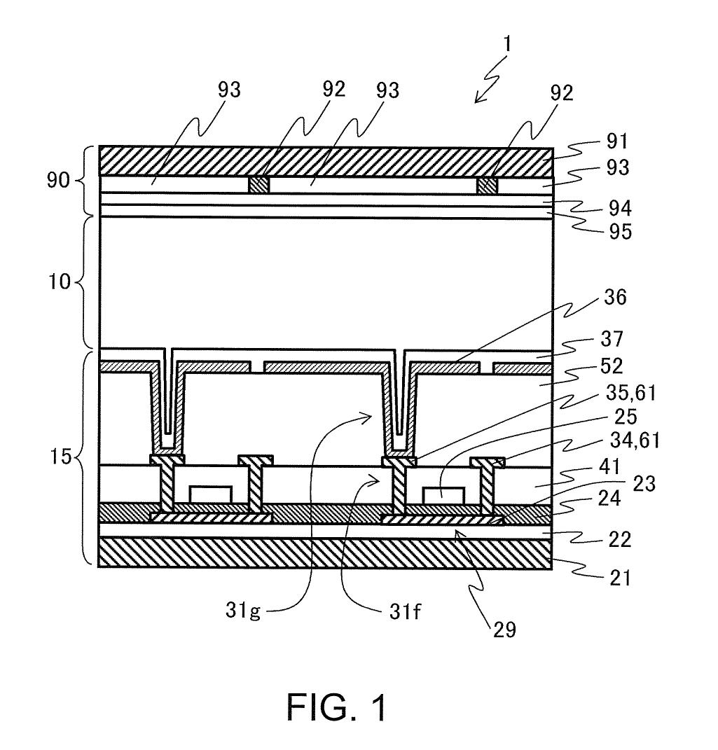

FIG. 1 is a schematic cross-sectional diagram of a pixel region of the liquid crystal display device as an example of the first embodiment of the invention.

The liquid crystal display device 1 shown in FIG. 1 as an example of the first embodiment of the invention is a VA-mode liquid crystal display device, more specifically a VA-mode liquid crystal display device of active matrix type using the PSA technique. The liquid crystal display device 1 is of transmission type, including an array substrate 15 being a substrate for a display device, and a color filter substrate 90 disposed facing the array substrate 15. Furthermore, by sealing a liquid crystal between the two substrates 15 and 90 by means of a seal material (not illustrated) provided around the two substrates 15 and 90, a liquid crystal layer 10 is formed.

The array substrate 15 has, in a pixel region being a display region in which a plurality of pixels are arrayed, a structure in which a substrate 21, an interlayer insulating film 52 and a pixel electrode 36 are provided in this order. More specifically, the array substrate 15 has, in the pixel region being a display region in which a plurality of pixels are arrayed, a structure in which on the insulating substrate 21, a base coat film 22, a semiconductor layer 23, a gate insulating film 24, a gate electrode 25, an inorganic insulating film 41, a source electrode 34 and a drain electrode 35 each including a first wiring layer 61, the interlayer insulating film 52, the pixel electrode 36 provided for each pixel, and an alignment film 37 provided to cover the pixel region are laminated in this order from the side of the substrate 21.

In this way, a TFT 29 that includes the semiconductor layer 23, the gate insulating film 24 and the gate electrode 25 and that functions as a pixel switching element is directly manufactured on the substrate 21 that constitutes the array substrate 15, for each pixel. The TFT 29 constitutes a so-called top gate-type TFT. The source electrode 34 and the drain electrode 35 each including the first wiring layer 61 are connected to a source/drain region of the semiconductor layer 23 through a contact hole 31f provided in the inorganic insulating film 41. In addition, the pixel electrode 36 is connected to the drain electrode 35 including the first wiring layer 61 through a contact hole 31g provided in the interlayer insulating film 52.

In addition, in a pixel region of the color filter substrate 90, on an insulating substrate 91, a black matrix 92 composed of a light shielding member provided between each pixel, red, green and blue color filters 93 provided for each pixel, a common electrode 94 composed of a transparent conductive film, and an alignment film 95 are formed in this order from the side of the substrate 91.

To explain the liquid crystal display device 1 in FIG. 1 in more detail, the substrate 21 is not particularly limited. For example, a glass substrate, a quartz substrate, and a resin substrate composed of acrylic resin or the like, etc. are suitably used. For the substrate 21, washing and pre-annealing are preferably performed as a pretreatment for constituting the array substrate 15.

The base coat film 22 on the substrate 21 can be formed by, e.g., forming a SiON film having a film thickness of 50 nm and a SiOx film having a film thickness of 100 nm in this order by a plasma-enhanced chemical vapor deposition (PECVD) method. Examples of a source gas for forming the SiON film include a mixed gas of monosilane (SiH₄), nitrous oxide gas (N₂O) and ammonia (NH₃), etc. Moreover, the SiOx film is preferably formed using tetraethyl orthosilicate (TEOS) gas as a source gas. In addition, the base coat film 22 may include a silicon nitride (SiNx) film formed using a mixed gas of monosilane (SiH₄) and ammonia (NH₃), or the like, as a source gas. The thickness of the base coat film 22 is preferably 80 nm or more and 600 nm or less, i.e., 80 nm to 600 nm.

The semiconductor layer 23 may be one foamed by patterning a polysilicon (p-Si) film in accordance with a well-known method. For example, the semiconductor layer 23 may be low-temperature polysilicon.

In addition, the semiconductor layer 23 can be formed using an oxide. Examples of the oxide applicable to the semiconductor layer 23 of the present embodiment include a single crystal oxide, a polycrystal oxide, and an amorphous oxide, as well as a mixture thereof. Examples of the polycrystal oxide include zinc oxide (ZnO), etc.

Examples of the amorphous oxide applicable to the semiconductor layer 23 include an amorphous oxide formed by containing at least one element of indium (In), zinc (Zn) and tin (Sn).

Specific examples of the amorphous oxide applicable to the semiconductor layer 23 include a Sn—Tn—Zn oxide, an In—Ga—Zn oxide (IGZO: indium gallium zinc oxide), an In—Zn—Ga—Mg oxide, a Zn—Sn oxide (ZTO: zinc tin oxide), an In oxide, a Ga oxide, an In—Sn oxide, an In—Ga oxide, an In—Zn oxide (IZO: indium zinc oxide), a Zn—Ga oxide, and a Sn—In—Zn oxide, and an In—Sn—Zn oxide (ITZO: indium tin zinc oxide), etc. Moreover, in the above cases, a composition ratio of the constituent materials is not necessarily, e.g., 1:1 or 1:1:1, and a composition ratio that realizes the desired properties can be selected.

The patterning of p-Si for forming the semiconductor layer 23 can be performed in accordance with a well-known method. For example, firstly, an amorphous silicon (a-Si) film having a film thickness of 50 nm is formed by the PECVD method. Examples of a source gas for forming the a-Si film include SiH₄, disilane (Si₂H₆), etc. The a-Si film formed by the PECVD method contains hydrogen. Therefore, a treatment (dehydrogenation treatment) that reduces the concentration of hydrogen in the a-Si film is performed at approximately 500° C. Next, laser annealing is performed to melt, cool and crystallize the a-Si film, thereby forming the p-Si film. The laser annealing can be performed using, e.g., an excimer laser. The formation of the p-Si film may be performed by, as a pretreatment prior to the laser annealing (for forming continuous grain silicon (CG silicon)), coating with a metal catalyst such as nickel or the like without performing the dehydrogenation treatment, and performing solid phase growth by way of a heat treatment. In addition, the crystallization of the a-Si film may be performed by solid phase growth alone, by way of a heat treatment. Next, dry etching is performed using a mixed gas of carbon tetrafluoride (CF₄) and oxygen (O₂), so as to pattern the p-Si film to form the semiconductor layer 23. The thickness of the semiconductor layer 23 is preferably 20 nm to 100 nm.

In the semiconductor layer 23, a channel region, a source region and a drain region that are not illustrated in the drawing are formed. These regions are formed in the semiconductor layer 23 after the later-described gate insulating film 24 is formed or after a further later described gate electrode is formed.

That is, in order to control a threshold voltage of the TFT 29, an impurity such as boron or the like is doped into the semiconductor layer 23 through the gate insulating film 24 by ion doping, ion implantation or the like.

In addition, an impurity such as phosphorus or boron or the like is doped at a higher concentration into the semiconductor layer 23 by ion doping, ion implantation or the like using the gate electrode 25 as a mask. Next, in order to activate the impurity ions existing in the semiconductor layer 23, a thermal activation treatment is performed at approximately 700° C. for 6 hours, thereby forming the source region and the drain region. Moreover, examples of a method for activating the impurity ions also include a method of irradiating with an excimer laser, etc.

The gate insulating film 24 may be, e.g., a silicon oxide film having a film thickness of 45 nm. The formation thereof can be performed using (TEOS) gas as a source gas. The material of the gate insulating film 24 is not particularly limited, and may be a SiNx film, a SiON film or the like. Examples of the source gas for forming the SiNx film and the SiON film include the same source gas as described in the forming step of the base coat film 22. In addition, the gate insulating film 24 may also be a laminate composed of the aforementioned plurality of materials. The thickness of the gate insulating film 24 is preferably 30 nm to 150 nm.

The gate electrode 25 is formed by forming a tantalum nitride (TaN) film having a film thickness of 30 nm and a tungsten (W) film having a film thickness of 370 nm in this order using a sputtering method, then patterning a resist film into a desired shape by a photolithography method so as to form a resist mask, and then performing dry etching using an etching gas including an adjusted quantity of mixed gas of argon (Ar), sulfur hexafluoride (SF₆), carbon tetrafluoride (CF₄), oxygen (O₂), and chlorine (Cl₂), etc. Examples of the material of the gate electrode 25 include a metal having an even surface, stable properties and a high melting point, such as tantalum (Ta), molybdenum (Mo), and molybdenum tungsten (MoW), etc., or a low-resistance metal such as aluminum (Al), etc. In addition, the gate electrode 25 may be a laminate composed of the aforementioned plurality of materials, and furthermore, may be, e.g., an alloy composed of a plurality of metals selected from Al, Cr, Ta, Mo, Ti, W, Cu, Nb, Mn, and Mg. The thickness of the gate electrode 25 is preferably 100 nm to 500 nm.

The inorganic insulating film 41 is formed by forming, on an entire surface of the substrate 21, a SiNx film having a film thickness of 100 nm to 400 nm, preferably 200 nm to 300 nm, and a TEOS film having a film thickness of 500 nm to 1000 nm, preferably 600 nm to 800 nm, by the PECVD method. The inorganic insulating film 41 may be a SiON film or the like. In addition, as properties of the TFT 29 deteriorate over time, a thin cap film (e.g., a TEOS film or the like) of about 50 nm may be formed underlying the inorganic insulating film 41, in order to stabilize electric properties of the TFT 29.

The contact hole 31f is formed by patterning a resist film into a desired shape by the photolithography method so as to form a resist mask, and then performing wet etching of the gate insulating film 24 and the inorganic insulating film 41 using a hydrofluoric acid-based etching solution. Moreover, the etching may also be dry etching.

The source electrode 34 and the drain electrode 35 include the first wiring layer 61, and are formed by the steps shown below. That is, a titanium (Ti) film having a film thickness of 100 nm, an aluminum (Al) film having a film thickness of 500 nm and a Ti film having a film thickness of 100 nm are formed in this order by sputtering or the like. Next, a resist film is patterned into a desired shape by the photolithography method so as to form a resist mask. Then, the Ti/Al/Ti metal laminated film is patterned by dry etching, and the first wiring layer 61 is formed. Accordingly, the source electrode 34 and the drain electrode 35 are formed. Moreover, an Al-Si alloy or the like may be used in place of Al as the metal that composes the first wiring layer 61. In addition, Al is used herein for lowering wiring resistance, but the aforementioned gate electrode materials (Ta, Mo, MoW, W, TaN, Al, etc.) may be used as the metal that composes the first wiring layer 61 if high heat resistance is required and a certain amount of increase in resistance values is allowable (e.g., in a case of short wiring structures).

The interlayer insulating film 52 is not particularly limited, and can be composed of either a non radiation-sensitive curable resin composition or a radiation-sensitive curable resin composition. The interlayer insulating film 52 is preferably formed using the radiation-sensitive resin composition of the second embodiment of the invention that is described later in detail, and is particularly preferably an organic insulating film having a planarization function. In that case, the interlayer insulating film 52 is preferably produced using the later-described radiation-sensitive resin composition of the second embodiment of the invention in accordance with the later-described method for producing an interlayer insulating film of the fourth embodiment of the invention.

The interlayer insulating film 52 has excellent ultraviolet transmission properties, and has a transmittance of 70% or higher for light having a wavelength of 310 nm at a film thickness of 2 μm. The film thickness of the interlayer insulating film 52 is preferably 1 μm to 5 μm, more preferably 2 μm to 3 μm, so as to sufficiently exhibit the insulation function and the planarization function.

As described above, the interlayer insulating film 52 is produced using, e.g., the radiation-sensitive resin composition of the second embodiment of the invention. In that case, a coating film of the radiation-sensitive resin composition of the second embodiment of the invention is formed on the entire surface of the substrate 21 by a spin coating method using a spinner, or the like. Next, exposure is performed through a photomask in which a light shielding pattern of a desired shape is formed, followed by etching (development treatment), thereby removing, e.g., the coating film in a region that serves as the contact hole 31g, so as to perform patterning. Further, heating is performed, e.g., at 200° C. for about 30 minutes, so as to produce the interlayer insulating film 52 as a cured film in which the contact hole 31g is formed.

The contact hole 31g is formed by the aforementioned patterning of the coating film of the radiation-sensitive resin composition of the second embodiment of the invention during production of the interlayer insulating film 52. Moreover, the interlayer insulating film 52 and a method for producing the same are explained later in detail.

The pixel electrode 36 is formed by forming an ITO (indium tin oxide) film or an IZO (indium zinc oxide) film having a film thickness of 50 nm to 200 nm, more preferably 100 nm to 150 nm using the sputtering method or the like:and then patterning the same into a desired shape by the photolithography method.

The alignment film 37 is formed on a surface of the array substrate 15 that contacts the liquid crystal layer 10 so as to cover at least the pixel region. The alignment film may be, e.g., an alignment film having a vertical alignment property and formed using a polymer material such as a polyimide or a polysiloxane or an acrylic polymer, etc. The alignment film having the vertical alignment property aligns a liquid crystal in the liquid crystal layer 10 so that the major-axis direction of the liquid crystal is perpendicular or substantially perpendicular to a substrate surface. Moreover, hereinafter, in this invention, a liquid crystal alignment in which the major-axis direction of the liquid crystal is perpendicular or substantially perpendicular to the substrate surface is simply called a perpendicular alignment or a vertical alignment. Accordingly, in the following descriptions of the invention, the “vertical alignment” of a liquid crystal include an alignment state in which the major-axis direction of the liquid crystal is completely perpendicular to the substrate surface and also an alignment state in which the major-axis direction of the liquid crystal is substantially perpendicular to the substrate surface.

Such alignment film 37 can be formed by forming a coating film of a liquid aligning agent prepared by containing a polyimide or a polysiloxane or an acrylic polymer, or a precursor thereof by, e.g., a print method, then heating and drying the coating film, and then subjecting the coating film to an alignment treatment if necessary.

Since the alignment film 37 is a vertical alignment type alignment film, by combining the alignment film 37 with the later-described liquid crystal in the liquid crystal layer 10 that has negative dielectric anisotropy, the liquid crystal display device 1 can be made a VA-mode liquid crystal display device.

Next, the substrate 91, the black matrix 92, the color filter 93, the common electrode 94 and the alignment film 95, etc. that constitute the color filter substrate 90 have the following structures.

The substrate 91 is an insulating substrate, same as the substrate 21 that constitutes the array substrate 15.

The black matrix 92 is formed by forming a light shielding film by the sputtering method and patterning the film.

The color filter 93 includes, as shown below, the red color filter 93, the green color filter 93 and the blue color filter 93. The red color filter 93 is formed by laminating a resin film (dry film) having a red pigment dispersed therein on an entire surface of the pixel region, and performing exposure, development and baking (heating treatment) thereof. The green color filter 93 is formed by laminating a resin film that overlaps the red color filter 93 and has a green pigment dispersed therein on the entire surface of the pixel region, and performing exposure, development and baking (heating treatment) thereof. The blue color filter 93 is formed in the same manner as the green color filter 93.

Moreover, the color filter substrate 90 may have, in a light shielding region outside a pixel opening, a columnar spacer (not illustrated) composed of a laminate of the light shielding film and the resin film.

The common electrode 94 is formed over the color filter 93 by vapor-depositing ITO.

The alignment film 95 is an alignment film same as the alignment film 37 of the array substrate 15.

Moreover, the color filter 93 of the color filter substrate 90 may also be formed by a photolithography method using a color resist. In addition, on the color filter substrate 90, a photospacer may be formed by the photolithography method using the color resist. Furthermore, the black matrix 92 may not be formed, and a wire such as a source line or a CS line of the array substrate 15 may be used instead.

In the liquid crystal display device 1 shown in FIG. 1 as an example of the first embodiment of the invention, by means of the seal material (not illustrated) provided around the array substrate 15 and the color filter substrate 90 disposed facing the array substrate 15, the liquid crystal or the like is sealed between the two substrates 15 and 90, thereby forming the liquid crystal layer 10.

Bonding of the array substrate 15 and the color filter substrate 90 using the seal material can be performed as follows. That is, the seal material was coated on an outer periphery of the pixel region of the array substrate 15. Then, a polymerizable liquid crystal composition prepared by adding a polymerizable component to a liquid crystal having negative dielectric anisotropy is dripped on the inside of the seal material using a dispenser or the like.

A material that can be used as the polymerizable component of the polymerizable liquid crystal composition is not particularly limited, and may be, e.g., a photopolymerizable monomer or a photopolymerizable oligomer. In addition, a thermally polymerizable monomer or a thermally polymerizable oligomer can be used. By containing such polymerizable component, the polymerizable liquid crystal composition can have photopolymerizability or thermal polymerizability.

Next, the color filter substrate 90 is bonded to the array substrate 15 having the polymerizable liquid crystal composition dripped thereon. The steps so far described are performed in a vacuum. Next, when the two bonded substrates 15 and 90 are put back into the atmosphere, the polymerizable liquid crystal composition diffuses between the two bonded substrates 15 and 90 due to atmospheric pressure. Next, the seal material is irradiated with UV (ultraviolet) light while a UV (ultraviolet) light source is moved along the region coated with the seal material, and the seal material is cured. In this manner, the polymerizable liquid crystal composition that has diffused is sandwiched and sealed between the pair of substrates 15 and 90 that face each other, and a layer of the polymerizable liquid crystal composition for forming the liquid crystal layer 10 is formed.

Moreover, a method for pouring the polymerizable liquid crystal composition between a pair of substrates may be a method of providing a liquid crystal composition inlet on one side of both the array substrate 15 and the color filter substrate 90, pouring the polymerizable liquid crystal composition therefrom, and then sealing the liquid crystal composition inlet with an ultraviolet-curable resin or the like.

Next, the formation of the liquid crystal layer 10 sealed between the array substrate 15 and the color filter substrate 90 can be performed as follows.

That is, as described above, the array substrate 15 and the color filter substrate 90 are bonded together, the polymerizable liquid crystal composition is sandwiched between the two substrates 15 and 90, and the layer of the polymerizable liquid crystal composition is formed between the two substrates 15 and 90. After that, while a voltage that turns on the TFT 29 is applied to the gate electrode 25, an AC voltage is applied between the source electrode 34 and the common electrode 94, so that a voltage is applied to tilt-align the liquid crystal. Next, while the liquid crystal remains tilt-aligned due to the voltage application, if the polymerizable liquid crystal composition has photopolymerizability, light that effectively acts on the photopolymerizability of the polymerizable liquid crystal composition, such as UV light, etc., is irradiated onto the layer of the polymerizable liquid crystal composition from the side of the array substrate 15. If the polymerizable liquid crystal composition has thermal polymerizability, heating for polymerizing the polymerizable component is performed.

By this light irradiation or heating, the polymerizable component contained in the polymerizable liquid crystal composition is polymerized, and a polymer that defines a pretilt angle of the liquid crystal is provided on surfaces of the alignment films 37 and 95 that face the liquid crystal layer 10. That is, since the polymerizable component is polymerized while the liquid crystal in the liquid crystal layer 10 remains tilted, the polymer that has memorized the direction in which the liquid crystal is tilted due to the voltage application can be provided on, e.g., the array substrate 15 that sandwiches the liquid crystal layer 10.

The liquid crystal display device 1 as an example of the first embodiment of the invention has the above structure, and a method for manufacturing the same includes a step of manufacturing the array substrate 15 having the aforementioned structure, a step of manufacturing the color filter substrate 90 having the aforementioned structure, and a step of sandwiching the polymerizable liquid crystal composition between the two substrates 15 and 90 and performing polymerization of the polymerizable component so as to form the liquid crystal layer 10. Furthermore, in the method for manufacturing the liquid crystal display device 1, through a panel cutting step, a polarizing plate attachment step, an FCP substrate attachment step, and a liquid crystal display panel and backlight unit combination step, etc., the liquid crystal display device 1 is manufactured.

According to the liquid crystal display device 1 as an example of the first embodiment of the invention, the interlayer insulating film 52 disposed between the substrate 21 and the pixel electrode 36 of the array substrate 15 has excellent light transmission properties in which the transmittance for light having a wavelength of 310 nm reaches 70% or higher at a film thickness of 2 μm. Therefore, reaction of the interlayer insulating film 52 caused by light, particularly the reaction caused by the more harmful light having a wavelength of 310 nm, can be reduced. As a result, in the liquid crystal display device 1 of the present embodiment, the defect that the interlayer insulating film 52 undergoes a photoreaction and generates a low molecular component to form bubbles in the pixel region can be reduced. That is, the liquid crystal display device 1 of the present embodiment has, on the array substrate 15 sandwiching the liquid crystal layer 10, the interlayer insulating film 52 along with the pixel electrode 36 and so on. Meanwhile, the interlayer insulating film 52 is the interlayer insulating film 52 in which bubbling is easily suppressed, and the bubbling defect conventionally regarded as a problem can be reduced.

Particularly, when it comes to the liquid crystal display device 1, the method for manufacturing the same can include the step of forming the liquid crystal layer 10, as described above. In the step of forming the liquid crystal layer 10, a step is sometimes included of, while a voltage is applied to the polymerizable liquid crystal composition sandwiched between the array substrate 15 and the color filter substrate 90, irradiating light from, e.g., the side of the array substrate 15.

Even in that case, in the liquid crystal display device 1, the interlayer insulating film 52 contained in the array substrate 15 is produced by, e.g., the later-described method for producing an interlayer insulating film of the fourth embodiment of the invention, and has excellent light transmission properties in which the transmittance for light having a wavelength of 310 nm reaches 70% or higher at a film thickness of 2 μm, as described above. As a result, the reaction of the interlayer insulating film 52 caused by light, particularly the reaction caused by the more harmful light having a wavelength of 310 nm, is reduced. Accordingly, in the VA-mode liquid crystal display device 1 that uses the PSA technique, the defect that the interlayer insulating film 52 undergoes a photoreaction and generates a low molecular component to form bubbles in the pixel region can be reduced.

Moreover, in the liquid crystal display device 1 of the first embodiment of the invention, the TFT 29 of the array substrate 15 constitutes the so-called top gate-type TFT, as described above. However, in the liquid crystal display device 1 of the first embodiment of the invention, the TFT of the array substrate is not necessarily of the top gate-type as shown in FIG. 1. For example, a so-called bottom gate-type TFT can also be used to constitute the array substrate.

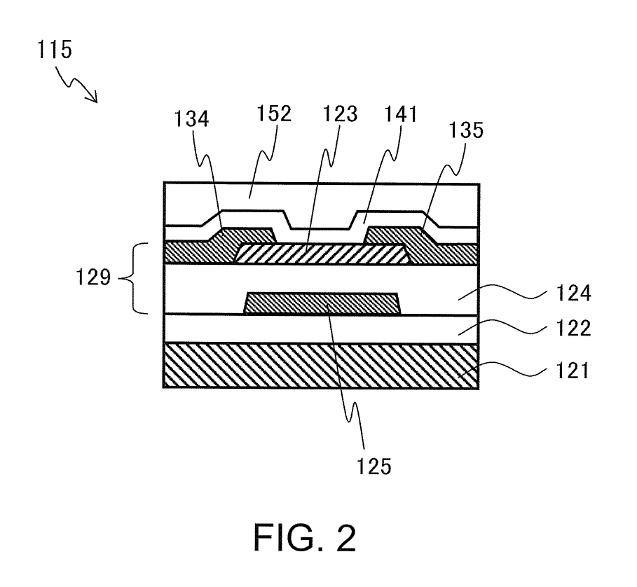

FIG. 2 is a schematic cross-sectional diagram explaining another example of the TFT that constitutes the array substrate of the liquid crystal display device of the first embodiment of the invention.

FIG. 2 shows an array substrate 115 that has a TFT 129 and that is used in another example of the structure of the liquid crystal display device of the first embodiment of the invention. The array substrate 115 is configured to include the TFT 129 disposed on a substrate 121, an inorganic insulating film 141 covering the TFT 129, and an interlayer insulating film 152 provided on the inorganic insulating film 141 so as to cover over the TFT 129. A pixel electrode (not illustrated) is disposed on the interlayer insulating film 152, and is electrically connected to the TFT 129 through a contact hole (not illustrated).

The bottom gate-type TFT 129 included in the array substrate 115 in FIG. 2 is configured to have, on the substrate 121 having a base coat film 122 formed on its surface similarly to the substrate 21 in the TFT 29 shown in FIG. 1, a gate electrode 125 forming a part of a gate wiring (not illustrated), a gate insulating film 124 covering the gate electrode 125, a semiconductor layer 123 disposed on the gate electrode 125 through the gate insulating film 124, a source electrode 134 forming a part of a signal wiring (not illustrated) and connected to the semiconductor layer 123, and a drain electrode 135 connected to the semiconductor layer 123. In the TFT 129, the semiconductor layer 123 is a layer composed of the same semiconductor as that of the semiconductor layer 23 in the TFT 29 shown in FIG. 1.

Moreover, in the semiconductor layer 123 of the TFT 129, in a channel region on an upper surface of the semiconductor layer 123 where neither the source electrode 134 nor the drain electrode 135 is formed, a protective layer (not illustrated) composed of SiO₂, for example, can be provided. This protective layer is sometimes also called an etching stop layer or a stop layer.

In the array substrate 115, as described above, the interlayer insulating film 152 can be disposed over the TFT 129 on the substrate 121 so as to cover the TFT 129. This interlayer insulating film 152 may be an organic insulating film having the planarization function, and is preferably formed using the radiation-sensitive resin composition of the second embodiment of the invention, similarly to the TFT 29 in FIG. 1.

In that case, in the array substrate 115, similarly to the interlayer insulating film 52 of the TFT 29, the interlayer insulating film 152 of the TFT 129 has excellent light transmission properties in which the transmittance for light having a wavelength of 310 nm reaches 70% or higher at a film thickness of 2 μm. Therefore, reaction of the interlayer insulating film 52 caused by light, particularly the reaction caused by the more harmful light having a wavelength of 310 nm, can be reduced. As a result, in the liquid crystal display device constituted using the array substrate 115, the defect that the interlayer insulating film 152 undergoes a photoreaction and generates a low molecular component to form bubbles in the pixel region can be reduced.

Next, the formation of the interlayer insulating film that is a main component of the liquid crystal display device of the first embodiment of the invention and that exhibits excellent transmission properties for light having a wavelength of 310 nm is explained in detail. Particularly, as described above, the interlayer insulating film in the liquid crystal display device of the first embodiment of the invention is formed using the radiation-sensitive resin composition of the second embodiment of the invention, and the radiation-sensitive resin composition of the second embodiment of the invention is hereinafter explained in detail.

### Second Embodiment

### <Radiation-Sensitive Resin Composition>

The radiation-sensitive resin composition of the second embodiment of the invention is used for producing the interlayer insulating film that is the main component of the liquid crystal display device of the first embodiment of the invention and that exhibits excellent transmission properties for light having a wavelength of 310 nm. More specifically, the radiation-sensitive resin composition of the present embodiment is used for producing the interlayer insulating film in the liquid crystal display device of the first embodiment of the invention, the interlayer insulating film having a transmittance of 70% or higher for light having a wavelength of 310 nm at a film thickness of 2 μm.

Accordingly, the radiation-sensitive resin composition of the second embodiment of the invention is prepared by selecting its constituents so that a cured film formed using the same has a transmittance of 70% or higher for light having a wavelength of 310 nm at a film thickness of 2 μm. Also, the preparation is performed by selecting the constituents, so that high radiation sensitivity is achieved, a fine and delicate pattern can be easily formed by exposure and development utilizing the high radiation sensitivity, and moreover, excellent hardness or heat resistance, etc. and high reliability are achieved. Compounds and so on that can be selected as the components of the radiation-sensitive resin composition of the second embodiment of the invention are hereinafter explained.

The radiation-sensitive resin composition of the second embodiment of the invention preferably contains [A] a polymer (hereinafter simply “[A] component”) and [B] a photosensitizer (hereinafter simply “[B] component”), and may further contain [C] a compound (hereinafter simply “[C] component”) functioning as a curing accelerator described later, and [D] a polymerizable unsaturated compound (hereinafter simply “[D] component”). In addition to the [A] component and the [B] component, as well as the [C] component and the [D] component that may be further contained, other optional components may also be contained as long as the effects of the invention are not impaired. Next, each of the components that can be contained in the radiation-sensitive resin composition of the present embodiment is specifically explained.

<[A] Polymer>

The [A] polymer as the [A] component of the radiation-sensitive resin composition of the second embodiment of the invention is a polymer containing a structural unit having a polymerizable group, i.e., a polymer having a polymerizable group, or a polyimide and a polyimide precursor.

In the [A] polymer, the polymerizable group is preferably at least one selected from the group consisting of an epoxy group, a (meth)acryloyl group and a vinyl group. That is, the [A] polymer is preferably a polymer having at least one group selected from the group consisting of an epoxy group, a (meth)acryloyl group and a vinyl group.

Since the [A] polymer has an epoxy group or the like as the polymerizable group as described above, by radiation irradiation, or heating, or by both radiation irradiation and heating, the radiation-sensitive resin composition of the present embodiment can be easily cured. A cured film formed using the radiation-sensitive resin composition of the present embodiment can be used as the interlayer insulating film in the aforementioned liquid crystal display device of the first embodiment of the invention.

The [A] polymer is preferably at least one selected from the group consisting of the following acrylic polymer, polyimide, polyimide precursor, siloxane-based polymer and epoxy resin. In the following, the preferred [A] polymer is explained.

(Acrylic Polymer)

A preferred acrylic polymer as the [A] polymer can be synthesized by radically polymerizing compounds that provide each structural unit in a solvent in the presence of a polymerization initiator. Each structural unit is hereinafter explained in detail.

[Structural Unit (a1)]

A structural unit (a1) is represented by the following formula (a). By having the structural unit (a1), the acrylic polymer is capable of enhancing curability and so on of the obtained cured film.

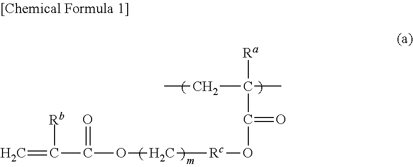

In the above formula (a), R^{a} and R^{b} are each independently a hydrogen atom or a methyl group. R^{c} is a divalent group represented by the following formula (a-i) or formula (a-ii). m is an integer of 1 to 6.

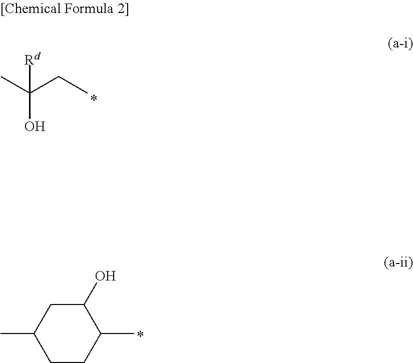

In the above formula (a-i), R^{d} is a hydrogen atom or a methyl group. In the above formulae (a-i) and (a-ii), * indicates a bonding site with an oxygen atom.

The structural unit (a1) is obtained by reacting a carboxy group in a later-described structural unit (a3) with an epoxy group contained in an epoxy group-containing (meth)acrylic compound to form an ester bond. In detail by giving a specific example, when a polymer having the structural unit (a3) is reacted with an epoxy group-containing (meth)acrylic compound such as glycidyl methacrylate and 2-methylglycidyl methacrylate or the like, R^{c} in the above formula (a) becomes a group represented by the above formula (a-i). On the other hand, when the polymer having the structural unit (a3) is reacted with an epoxy group-containing (meth)acrylic compound such as 3,4-epoxycyclohexylmethyl methacrylate or the like, R^{c} in the above formula (a) becomes a group represented by the above formula (a-ii).

A content ratio of the structural unit (a1) is preferably 5 mol % to 60 mol %, more preferably 10 mol % to 50 mol %, with respect to total structural units that constitute the acrylic polymer. By adjusting the content ratio of the structural unit (a1) to the above range, a cured film having excellent curability and so on can be formed.

[Structural Unit (a2)]

The structural unit (a2) is a structural unit derived from an epoxy group-containing unsaturated compound. By having the structural unit (a2), the acrylic polymer is capable of further enhancing curability and so on of the obtained cured film.

Examples of the epoxy group include an oxiranyl group (1,2-epoxy structure) and an oxetanyl group (1,3-epoxy structure).

Examples of an unsaturated compound containing the oxiranyl group include glycidyl acrylate, glycidyl methacrylate, α-ethylglycidyl acrylate, α-n-propylglycidyl acrylate, α-n-butylglycidyl acrylate, 3,4-epoxybutyl acrylate, 3,4-epoxybutyl methacrylate, 6,7-epoxyheptyl acrylate, 6,7-epoxyheptyl methacrylate, 6,7-epoxyheptyl α-ethylacrylate, o-vinylbenzyl glycidyl ether, m-vinylbenzyl glycidyl ether, p-vinylbenzyl glycidyl ether, and 3,4-epoxycyclohexyl methacrylate, etc.

Examples of an unsaturated compound containing the oxetanyl group include: as an acrylic ester, 3-(acryloyloxymethyl)oxetane, 3-(acryloyloxymethyl)-2-methyloxetane, 3-(acryloyloxymethyl)-3-ethyloxetane, 3-(acryloyloxymethyl)-2-trifluoromethyloxetane, 3-(acryloyloxymethyl)-2-pentafluoroethyloxetane, 3-(acryloyloxymethyl)-2-phenyloxetane, 3-(acryloyloxymethyl)-2,2-difluorooxetane, 3-(acryloyloxymethyl)-2,2,4-trifluorooxetane, 3-(acryloyloxymethyl)-2,2,4,4-tetrafluorooxetane, 3-(2-acryloyloxyethyl)oxetane, 3-(2-acryloyloxyethyl)-2-ethyloxetane, 3-(2-acryloyloxyethyl)-3-ethyloxetane, 3-(2-acryloyloxyethyl)-2-trifluoromethyloxetane, 3-(2-acryloyloxyethyl)-2-pentafluoroethyloxetane, 3-(2-acryloyloxyethyl)-2-phenyloxetane, 3-(2-acryloyloxyethyl)-2,2-difluorooxetane, 3-(2-acryloyloxyethyl)-2,2,4-trifluorooxetane, and 3-(2-acryloyloxyethyl)-2,2,4,4-tetrafluorooxetane, etc.; and

as a methacrylic ester, 3-(methacryloyloxymethyl)oxetane, 3-(methacryloyloxymethyl)-2-methyloxetane, 3-(methacryloyloxymethyl)-3-ethyloxetane, 3-(methacryloyloxymethyl)-2-trifluoromethyloxetane, 3-(methacryloyloxymethyl)-2-pentafluoroethyloxetane, 3-(methacryloyloxymethyl)-2-phenyloxetane, 3-(methacryloyloxymethyl)-2,2-difluorooxetane, 3-(methacryloyloxymethyl)-2,2,4-trifluorooxetane, 3-(methacryloyloxymethyl)-2,2,4,4-tetrafluorooxetane, 3-(2-methacryloyloxyethyl)oxetane, 3-(2-methacryloyloxyethyl)-2-ethyloxetane, 3-(2-methacryloyloxyethyl)-3-ethyloxetane, 3-(2-methacryloyloxyethyl)-2-trifluoromethyloxetane, 3-(2-methacryloyloxyethyl)-2-pentafluoroethyloxetane, 3-(2-methacryloyloxyethyl)-2-phenyloxetane, 3-(2-methacryloyloxyethyl)-2,2-difluorooxetane, 3-(2-methacryloyloxyethyl)-2,2,4-trifluorooxetane, and 3-(2-methacryloyloxyethyl)-2,2,4,4-tetrafluorooxetane, etc.

Among them, from the viewpoint of enhancing reactivity and solvent resistance of the cured film, glycidyl methacrylate, 2-methylglycidyl methacrylate, 6,7-epoxyheptyl methacrylate, o-vinylbenzyl glycidyl ether, m-vinylbenzyl glycidyl ether, p-vinylbenzyl glycidyl ether, 3,4-epoxycyclohexyl methacrylate, and 3,4-epoxytricyclo[5.2.1.0^{2.6}]decyl(meth)acrylate are preferred, glycidyl methacrylate, 2-methylglycidyl methacrylate and 6,7-epoxyheptyl methacrylate are more preferred, and glycidyl methacrylate is even more preferred.

A content ratio of the structural unit (a2) is preferably 5 mol % to 60 mol %, more preferably 10 mol % to 50 mol %, with respect to total structural units that constitute the acrylic polymer. By adjusting the content ratio of the structural unit (a2) to the above range, a cured film having excellent curability and so on can be formed.

[Structural Unit (a3)]

The structural unit (a3) is at least one structural unit selected from the group consisting of a structural unit derived from an unsaturated carboxylic acid and a structural unit derived from an unsaturated carboxylic anhydride. Examples of the compound that provides the structural unit (a3) include an unsaturated monocarboxylic acid, an unsaturated dicarboxylic acid, an anhydride of an unsaturated dicarboxylic acid, a mono[(meth)acryloyloxyalkyl] ester of a polycarboxylic acid, a mono(meth)acrylate of a polymer having a carboxy group and a hydroxyl group at both ends, and an unsaturated polycyclic compound having a carboxy group and an anhydride thereof, etc.

Examples of the unsaturated monocarboxylic acid include acrylic acid, methacrylic acid, and crotonic acid, etc. Examples of the unsaturated dicarboxylic acid include maleic acid, fumaric acid, citraconic acid, mesaconic acid, and itaconic acid, etc. Examples of the anhydride of an unsaturated dicarboxylic acid include an anhydride of the compound mentioned above as an example of dicarboxylic acid, etc. Examples of the mono[(meth)acryloyloxyalkyl] ester of a polycarboxylic acid include mono[2-(meth)acryloyloxyethyl] succinate, and mono [2-(meth)acryloyloxyethyl] phthalate, etc. Examples of the mono(meth)acrylate of a polymer having a carboxyl group and a hydroxyl group at both ends include ω-carboxypolycaprolactone mono(meth)acrylate, etc. Examples of the unsaturated polycyclic compound having a carboxyl group and the anhydride thereof include 5-carboxybicyclo[2.2.1]hept-2-ene, 5,6-dicarboxybicyclo[2.2.1]hept-2-ene, 5-carboxy-5-methylbicyclo[2.2.1]hept-2-ene, 5-carboxy-5-ethylbicyclo[2.2.1]hept-2-ene, 5-carboxy-6-methylbicyclo[2.2.1]hept-2-ene, 5-carboxy-6-ethylbicyclo[2.2.1]hept-2-ene, and 5,6-dicarboxybicyclo[2.2.1]hept-2-ene anhydride, etc.

Among them, monocarboxylic acid and an anhydride of dicarboxylic acid are preferred. In view of copolymerization reactivity, solubility in alkali aqueous solution and ease of availability, (meth)acrylic acid and maleic anhydride are more preferred.

A content ratio of the structural unit (a3) is preferably 5 mol % to 30 mol %, more preferably 10 mol % to 25 mol %, with respect to total structural units that constitute the acrylic polymer. By adjusting the content ratio of the structural unit (a3) to the above range, the solubility of the acrylic polymer in alkali aqueous solution is optimized, and a resin composition having excellent sensitivity is obtained.

The acrylic polymer may be an alkali-soluble resin that dissolves in an alkali developer (e.g., 0.40 mass % potassium hydroxide aqueous solution at 23° C., etc.). By containing the acrylic polymer as the [A] polymer in the resin composition of the present embodiment, the solubility in alkali aqueous solution can be optimized. The acrylic polymer is preferably a copolymer. In addition, the acrylic polymer preferably has the structural unit (a3) when the alkali solubility is exhibited.

Moreover, the acrylic polymer may have a structural unit other than the aforementioned structural units without impairing the effects of the invention. In addition, the acrylic polymer may have two or more of the aforementioned structural units.

[Other Structural Units]

Examples of a compound that may be contained in the acrylic polymer without impairing the effects of the invention and that provides a structural unit other than the structural units (a1) to (a3) include a (meth)acrylic ester having a hydroxyl group, a (meth)acrylic acid chain alkyl ester, a (meth)acrylic acid cyclic alkyl ester, a (meth)acrylic acid aryl ester, an unsaturated aromatic compound, a conjugated diene, an unsaturated compound having a tetrahydrofuran skeleton or the like, and a maleimide, etc.

Examples of the (meth)acrylic ester having a hydroxyl group include 2-hydroxyethyl acrylate, 3-hydroxypropyl acrylate, 4-hydroxybutyl acrylate, 5-hydroxypentyl acrylate, 6-hydroxyhexyl acrylate, 2-hydroxyethyl methacrylate, 3-hydroxypropyl methacrylate, 4-hydroxybutyl methacrylate, 5-hydroxypentyl methacrylate, 6-hydroxyhexyl methacrylate, and 4-(α-hydroxyhexafluoroisopropyl)styrene, etc.

Examples of the (meth)acrylic acid chain alkyl ester include methyl methacrylate, ethyl methacrylate, n-butyl methacrylate, sec-butyl methacrylate, t-butyl methacrylate, 2-ethylhexyl methacrylate, isodecyl methacrylate, n-lauryl methacrylate, tridecyl methacrylate, n-stearyl methacrylate, methyl acrylate, ethyl acrylate, n-butyl acrylate, sec-butyl acrylate, t-butyl acrylate, 2-ethylhexyl acrylate, isodecyl acrylate, n-lauryl acrylate, tridecyl acrylate, and n-stearyl acrylate, etc.

Examples of the (meth)acrylic acid cyclic alkyl ester include cyclohexyl methacrylate, 2-methylcyclohexyl methacrylate, tricyclo[5.2.1.02,6]decan-8-yl methacrylate, tricyclo[5.2.1.02,6]decan-8-yloxyethyl methacrylate, isoboronyl methacrylate, cyclohexyl acrylate, 2-methylcyclohexyl acrylate, tricyclo[5.2.1.02,6]decan-8-yl acrylate, tricyclo[5.2.1.02,6]decan-8-yloxyethyl acrylate, and isoboronyl acrylate, etc.

Examples of the (meth)acrylic acid aryl ester include phenyl methacrylate, benzyl methacrylate, phenyl acrylate, and benzyl acrylate, etc.

Examples of the unsaturated aromatic compound include styrene, α-methylstyrene, o-methylstyrene, m-methylstyrene, p-methylstyrene, and p-methoxystyrene, etc.

Examples of the conjugated diene include 1,3-butadiene, isoprene, and 2,3-dimethyl-1,3-butadiene, etc.

Examples of the unsaturated compound having a tetrahydrofuran skeleton include tetrahydrofurfuryl (meth)acrylate, 2-methacryloyloxy-propionic acid tetrahydrofurfuryl ester, and 3-(meth)acryloyloxytetrahydrofuran-2-one, etc.

Examples of the maleimide include N-phenylmaleimide, N-cyclohexylmaleimide, N-tolylmaleimide, N-naphthylmaleimide, N-ethylmaleimide, N-hexylmaleimide, and N-benzylmaleimide, etc.

Examples of a solvent used in a polymerization reaction for synthesizing the acrylic polymer include an alcohol, a glycol ether, an ethylene glycol alkyl ether acetate, a diethylene glycol monoalkyl ether, a diethylene glycol dialkyl ether, a dipropylene glycol dialkyl ether, a propylene glycol monoalkyl ether, a propylene glycol alkyl ether acetate, a propylene glycol monoalkyl ether propionate, a ketone, and an ester, etc.

A polymerization initiator used in the polymerization reaction for synthesizing the acrylic polymer may be one commonly known as a radical polymerization initiator. Examples of the radical polymerization initiator include an azo compound, such as 2,2′-azobisisobutyronitrile, 2,2′-azobis-(2,4-dimethylvaleronitrile), and 2,2′-azobis-(4-methoxy-2,4-dimethylvaleronitrile), etc.

In the polymerization reaction for synthesizing the acrylic polymer, a molecular weight modifier can be used for adjusting a molecular weight. Examples of the molecular weight modifier include halogenated hydrocarbons, such as chloroform and carbon tetrabromide, etc.; mercaptans, such as n-hexyl mercaptan, n-octyl mercaptan, n-dodecyl mercaptan, t-dodecyl mercaptan, and thioglycolic acid, etc.; xanthogens, such as dimethylxanthogen sulfide and diisopropylxanthogen disulfide, etc., terpinolene; and α-methylstyrene dimer, etc.

A weight average molecular weight (Mw) of the acrylic polymer is preferably 1000 to 30000, more preferably 5000 to 20000, in terms of polystyrene conversion using gel permeation chromatography (GPC). By adjusting the Mw of the acrylic polymer to the above range, the sensitivity and developability of the resin composition containing the acrylic polymer as the [A] polymer can be increased.

(Polyimide and Polyimide Precursor)

The preferred polyimide and polyimide precursor as the [A] polymer in the radiation-sensitive resin composition of the present embodiment include a polyimide resin having, in a structural unit of a polymer, at least one selected from the group consisting of a carboxyl group, a phenolic hydroxyl group, a sulfonic acid group and a thiol group. By having these alkali-soluble groups in the structural unit, formation of scum in an exposed portion can be prevented during alkali development. In addition, if a fluorine atom is contained in the structural unit, during development using an alkali aqueous solution, water repellency is imparted to an interface between films, and permeation into the interface or the like is suppressed, which is therefore preferred. The content of the fluorine atom in the polyimide resin is preferably 10% by mass or more in order to obtain a sufficient effect of preventing the interface permeation, and is preferably 20% by mass or less in view of the solubility in alkali aqueous solution.

The preferred polyimide and polyimide precursor as the [A] polymer in the radiation-sensitive resin composition of the present embodiment are not particularly limited, and preferably have a structural unit represented by the following formula (I-1).

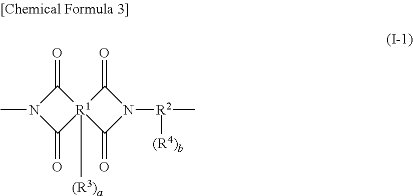

In the above formula (I-1), R¹ represents a 4- to 14-valent organic group, and R² represents a 2- to 12-valent organic group. R³ and R⁴ indicate a carboxyl group, a phenolic hydroxyl group, a sulfonic acid group or a thiol group, and may be the same as or different from each other. a and b represent an integer of 0 to 10.

In the above formula (I-1), R¹ represents a residue of tetracarboxylic dianhydride and is a 4- to 14-valent organic group, wherein R¹ is preferably an organic group containing an aromatic ring or a cyclic aliphatic group and having 5 to 40 carbon atoms.

Preferred examples of the tetracarboxylic dianhydride include 3,3′,4,4′-biphenyltetracarboxylic dianhydride, 2,3,3′,4′-biphenyltetracarboxylic dianhydride, 2,2′,3,3′-biphenyltetracarboxylic dianhydride, 3,3′,4,4′-benzophenone tetracarboxylic dianhydride, 2,2′,3,3′-benzophenone tetracarboxylic dianhydride, 2,2-bis(3,4-dicarboxyphenyl)propane dianhydride, 2,2-bis(2,3-dicarboxyphenyl)propane dianhydride, 1,1-bis(3,4-dicarboxyphenyl)ethane dianhydride, 1,1-bis(2,3-dicarboxyphenyl)ethane dianhydride, bis(3,4-dicarboxyphenyl)methane dianhydride, bis(2,3-dicarboxyphenyl)methane dianhydride, bis(3,4-dicarboxyphenyl)sulfone dianhydride, bis(3,4-dicarboxyphenyl)etherdianhydride, 2,2-bis(3,4-dicarboxyphenyl)hexafluoropropane dianhydride, 3,3′,4,4′-diphenylsulfone tetracarboxylic dianhydride, 9,9-bis(3,4-dicarboxyphenyl)fluorene dianhydride, 9,9-bis{4-(3,4-dicarboxyphenoxy)phenyl}fluorene dianhydride, or dianhydrides having the structures shown below. Two or more of them may be used together.

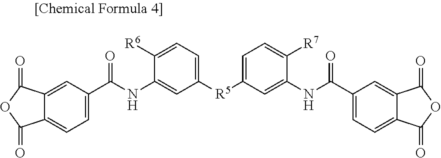

R⁵ indicates an oxygen atom, C(CF₃)₂, C(CH₃)₂ or SO₂. R⁶ and R⁷ indicate a hydrogen atom, a hydroxyl group or a thiol group.

In the above formula (I-1), R² represents a residue of diamine and is a 2- to 12-valent organic group, wherein R² is preferably an organic group containing an aromatic ring or a cyclic aliphatic group and having 5 to 40 carbon atoms.

Specific preferred examples of the diamine include 3,3′-diaminodiphenyl ether, 3,4′-diaminodiphenyl ether, 4,4′-diaminodiphenyl ether, 3,3′-diaminodiphenyl methane, 3,4′-diaminodiphenyl methane, 4,4′-diaminodiphenyl methane, 3,3′-diaminodiphenyl sulfone, 3,4′-diaminodiphenyl sulfone, 4,4′-diaminodiphenyl sulfone, 3,3′-diaminodiphenyl sulfide, 3,4′-diaminodiphenyl sulfide, 4,4′-diaminodiphenyl sulfide, m-phenylenediamine, p-phenylenediamine, 1,4-bis(4-aminophenoxy)benzene, 9,9-bis(4-aminophenyl)fluorene, or diamines having the structures shown below. Two or more of them may be used together.

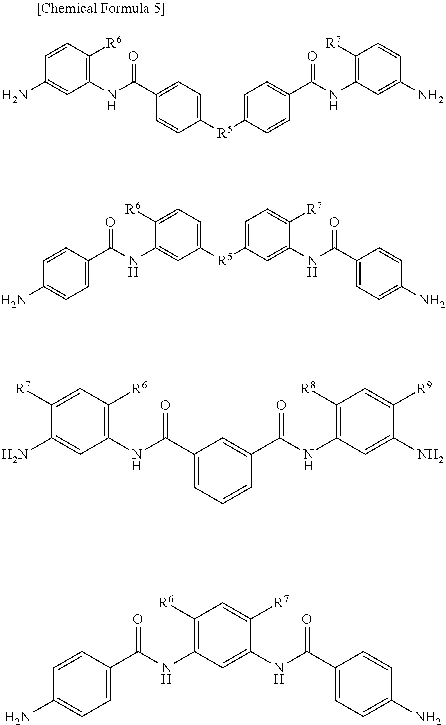

R⁵ indicates an oxygen atom, C(CF₃)₂, C(CH₃)₂ or SO₂. R⁶ to R⁹ indicate a hydrogen atom, a hydroxyl group or a thiol group.

In addition, in order to enhance adhesiveness with a substrate, R¹ or R² may be copolymerized with an aliphatic group having a siloxane structure without reducing heat resistance. Specifically, examples of the diamine component include one obtained by copolymerizing 1 mol % to 10 mol % of bis(3-aminopropyl)tetramethyldisiloxane and bis(p-aminophenyl)octamethylpentasiloxane, etc.

In the above formula (I-1), R³ and R⁴ indicate a carboxyl group, a phenolic hydroxyl group, a sulfonic acid group or a thiol group. a and b indicate an integer of 0 to 10. In view of stability of the obtained radiation-sensitive resin composition, a and b are preferably 0; from the viewpoint of the solubility in alkali aqueous solution, a and b are preferably 1 or greater.

By adjusting an amount of the alkali-soluble group in R³ and R⁴, a dissolution rate in alkali aqueous solution is changed. Thus, a radiation-sensitive resin composition having a proper dissolution rate can be obtained by this adjustment.

When both R³ and R⁴ are phenolic hydroxyl groups, in order to control the dissolution rate in a 2.38 mass % tetramethylammonium hydroxide (TMAH) aqueous solution to be in a more suitable range, it is preferred that 2 mol to 4 mol of the phenolic hydroxyl group be contained in (a) 1 kg of (a) the polyimide resin. By adjusting the amount of the phenolic hydroxyl group to this range, a radiation-sensitive resin composition having higher sensitivity and a high contrast is obtained.

In addition, the polyimide having the structural unit represented by the above formula (I-1) preferably has an alkali-soluble group at a main chain end. Such polyimide has high alkali solubility.

Specific examples of the alkali-soluble group include a carboxyl group, a phenolic hydroxyl group, a sulfonic acid group, and a thiol group, etc. The introduction of the alkali-soluble group to the main chain end can be performed by providing an end capping agent with the alkali-soluble group. The end capping agent may be a monoamine, an anhydride, a monocarboxylic acid, a monoacid chloride compound, and a mono active ester compound, etc.

Preferred examples of the monoamine used as the end capping agent include 5-amino-8-hydroxyquinoline, 1-hydroxy-7-aminonaphthalene, 1-hydroxy-6-aminonaphthalene, 1-hydroxy-5-aminonaphthalene, 1-hydroxy-4-aminonaphthalene, 2-hydroxy-7-aminonaphthalene, 2-hydroxy-6-aminonaphthalene, 2-hydroxy-5-aminonaphthalene, 1-carboxy-7-aminonaphthalene, 1-carboxy-6-aminonaphthalene, 1-carboxy-5-aminonaphthalene, 2-carboxy-7-aminonaphthalene, 2-carboxy-6-aminonaphthalene, 2-carboxy-5-aminonaphthalene, 2-aminobenzoic acid, 3-aminobenzoic acid, 4-aminobenzoic acid, 4-aminosalicylic acid, 5-aminosalicylic acid, 6-aminosalicylic acid, 2-aminobenzenesulfonic acid, 3-aminobenzenesulfonic acid, 4-aminobenzenesulfonic acid, 3-amino-4,6-dihydroxypyrimidine, 2-aminophenol, 3-aminophenol, 4-aminophenol, 2-aminothiophenol, aminothiophenol, and 4-aminothiophenol, etc. Two or more of them may be used together.

Preferred examples of the anhydride, the monocarboxylic acid, the monoacid chloride compound, and the mono active ester compound used as the end capping agent include: an anhydride, such as phthalic anhydride, maleic anhydride, nadic anhydride, cyclohexanedicarboxylic anhydride, and 3-hydroxyphthalic anhydride, etc.; monocarboxylic acids such as 3-carboxyphenol, 4-carboxyphenol, 3-carboxythiophenol, 4-carboxythiophenol, 1-hydroxy-7-carboxynaphthalene, 1-hydroxy-6-carboxynaphthalene, 1-hydroxy-5-carboxynaphthalene, 1-mercapto-7-carboxynaphthalene, 1-mercapto-6-carboxynaphthalene, 1-mercapto-5-carboxynaphthalene, 3-carboxybenzenesulfonic acid, and 4-carboxybenzenesulfonic acid, etc., and a monoacid chloride compound in which the carboxyl group in these monocarboxylic acids is converted to an acid chloride; a monoacid chloride compound in which only one of the carboxyl groups in dicarboxylic acids such as terephthalic acid, phthalic acid, maleic acid, cyclohexanedicarboxylic acid, 1,5-dicarboxynaphthalene, 1,6-dicarboxynaphthalene, 1,7-dicarboxynaphthalene, and 2,6-dicarboxynaphthalene, etc. is converted to an acid chloride; and an active ester compound obtained by reacting a monoacid chloride compound with N-hydroxybenzotriazole or N-hydroxy-5-norbornene-2,3-dicarboxyimide, etc. Two or more of them may be used together.

An introduction ratio of the monoamine used for the end capping agent is preferably 0.1 mol % or more, particularly preferably 5 mol % or more, and preferably 60 mol % or less, particularly preferably 50 mol % or less, with respect to total amine components. An introduction ratio of the anhydride, the monocarboxylic acid, the monoacid chloride compound or the mono active ester compound used as the end capping agent is preferably 0.1 mol % or more, particularly preferably 5 mol % or more, and preferably 100 mol % or less, particularly preferably 90 mol % or less, with respect to the diamine component. A plurality of different end groups may be introduced by reacting a plurality of end capping agents.

In the polyimide having the structural unit represented by the above formula (I-1), a number of repetitions of the structural unit is preferably 3 or greater, more preferably 5 or greater, and preferably 200 or less, more preferably 100 or less. If this range is satisfied, the use of the radiation-sensitive resin composition of the present embodiment in a thick film becomes possible.

In the present embodiment, a preferred polyimide resin may contain only the structural unit represented by the above formula (I-1), or may be a copolymer or mixture of the same and other structural units. In that case, the structural unit represented by general formula (I-1) is preferably contained in an amount of 10% by mass or more of the entirety of the polyimide resin. If the content is 10% by mass or more, shrinkage during thermal curing can be suppressed, which is suitable for production of a thick film. The types and quantities of the structural units used in the copolymerization or mixing are preferably selected without impairing the heat resistance of the polyimide obtained by a final heating treatment. Examples thereof include benzoxazole, benzimidazole, and benzothiazole, etc. These structural units are preferably contained in the polyimide resin in an amount of 70% by mass or less.

In the present embodiment, the preferred polyimide resin can be synthesized by, e.g., obtaining a polyimide precursor using a well-known method, and imidizing the polyimide precursor by a well-known imidization reaction method. In a well-known method for synthesizing a polyimide precursor, part of a diamine is replaced with a monoamine as the end capping agent, or part of a dianhydride is replaced with a monocarboxylic acid, an anhydride, a monoacid chloride compound or a mono active ester compound as the end capping agent, and the amine component and the acid component react with each other to obtain the polyimide precursor. For example, there are a method of reacting tetracarboxylic dianhydride with a diamine compound (part of which being replaced with a monoamine) at low temperature, a method of reacting tetracarboxylic dianhydride (part of which being replaced with an anhydride, a monoacid chloride compound or a mono active ester compound) with a diamine compound, a method of obtaining a diester by tetracarboxylic dianhydride and an alcohol and then reacting the diester with a diamine (part of which being replaced with a monoamine) in the presence of a condensing agent, and a method of obtaining a diester by tetracarboxylic dianhydride and an alcohol, and then converting the remaining dicarboxylic acid to an acid chloride and reacting the same with a diamine (part of which being replaced with a monoamine), etc.

In addition, an imidization rate of the polyimide resin can be easily obtained by, e.g., the following method. Firstly, an infrared absorption spectrum of a polymer is measured to confirm the existence of an absorption peak (at around 1780 cm⁻¹ and around 1377 cm⁻¹) of an imide structure derived from a polyimide. Next, the polymer is subjected to a heat treatment at 350° C. for 1 hour, and the infrared absorption spectrum is measured. By comparing peak intensities around 1377 cm⁻¹, the content of imide group in the polymer before the heat treatment is calculated, so as to obtain the imidization rate.

In the present embodiment, the imidization rate of the polyimide resin is preferably 80% or higher in view of chemical resistance and a high shrinkage residual film rate.

In addition, in the present embodiment, an end capping agent introduced to the preferred polyimide resin can be easily detected by the following method. For example, the end capping agent used in the invention can be easily detected by dissolving a polyimide to which the end capping agent is introduced in an acidic solution to decompose the polyimide into an amine component and an anhydride component that are structural units of the polyimide, and measuring them by gas chromatography (GC) or NMR. Alternatively, by directly measuring the polymer component to which the end capping agent is introduced by pyrolysis-gas chrochromatography (PGC) or an infrared spectrum and a 13C-NMR spectrum, the end capping agent can be detected easily.

(Siloxane-Based Polymer)

[Siloxane Polymer (b)]

A siloxane polymer (b) that can be used as a siloxane-based polymer as the [A] polymer is a polysiloxane having a radically polymerizable organic group, obtained by cohydrolysis-condensation of (b1) a silane compound (hereinafter also “(b1) compound”) having a radically polymerizable organic group and (b2) a silane compound (hereinafter also “(b2) compound”) having no radically polymerizable organic group, wherein a proportion of the (b1) compound in the polysiloxane exceeds 15 mol %. The siloxane polymer (b) has a radically polymerizable organic group as the polymerizable group.

The (b1) compound is preferably a hydrolyzable silane compound represented by the following formula (1) or (2).

[Chemical Formula 6]

(R¹¹O₃Si—R¹²—X (1) (1)

(In formula (1), R¹¹ indicates an alkyl group having 1 to 4 carbons; R¹² indicates a single bond, a methylene group or an alkylene group; and X indicates a vinyl group, an allyl group, a styryl group or a (meth)acryloyl group.)

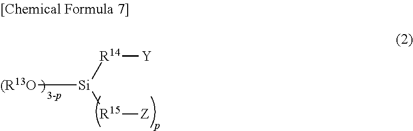

(In formula (2), R¹³ indicates an alkyl group having 1 to 4 carbons; R¹⁴ and R¹⁵ indicate a single bond, a methylene group or an alkylene group; Y indicates a vinyl group, an allyl group, a styryl group or a (meth)acryloyl group; Z indicates a hydrogen atom, an alkyl group having 1 to 20 carbons, a substituted or unsubstituted aryl group having 6 to 14 carbons, a halogen atom, an epoxy group, an isocyanate group, an amino group, a vinyl group, a styryl group or a (meth)acryloyl group. p is an integer of 1 or 2.)

Herein, the “hydrolyzable silane compound” in the invention is referred to as “silane compound having a hydrolyzable group,” and the term “hydrolyzable group” as mentioned herein generally refers to a group capable of forming a silanol group (—Si—OH) by reaction with water. In contrast, the term “non-hydrolyzable group” refers to a group that stably exists without forming a silanol group by reaction with water. In addition, the term “hydrolysis-condensation” means formation of a siloxane bond (—Si—O—Si—) by at least one of a dehydration condensation reaction between silanol groups generated by hydrolysis and a condensation reaction between a silanol group and a hydrolyzable group. Moreover, in the hydrolysis reaction, if a silanol group is formed from part of a hydrolyzable group, a non-hydrolyzable group (—OR¹ or —OR³) may remain. That is, part of the siloxane polymer (b) may have at least one of —OR¹ or —OR³.

The alkyl group for R¹¹, R¹³ and Z may be linear or branched. From the viewpoint of reactivity for hydrolysis-condensation, the alkyl group for R¹¹ and R¹³ is preferably an alkyl group having 1 to 2 carbons. In addition, the alkyl group for Z is preferably an alkyl group having 1 to 6 carbons, particularly preferably an alkyl group having 1 to 4 carbons.

The alkylene group for R¹², R¹⁴ and R¹⁵ is preferably an alkylene group having 2 to 6 carbons, particularly preferably an alkylene group having 2 to 3 carbons. This alkylene group may be linear or branched, and specific examples thereof include an ethylene group, a trimethylene group and a propylene group.

The (meth)acryloyl group for X, Y and Z is a concept including acryloyl group and methacryloyl group. In addition, a substitution position of the vinyl group on an aromatic ring of the styryl group is not particularly limited, and may be an ortho position, a meta position or a para position.

Examples of the aryl group for Z include monocyclic to tricyclic aromatic hydrocarbon groups. The aryl group may have a substituent as long as its carbon number is 6 to 14. Examples of the substituent include an alkyl group having 1 to 6 carbons, a halogen atom, a hydroxyl group, an amino group, a nitro group, a cyano group, a carboxyl group, and an alkoxy group. Examples of the aryl group include a phenyl group and a naphthyl group; examples of the substituted aryl group include a tolyl group.

In the above formula (1), R¹¹ is preferably an alkyl group having 1 to 2 carbons, R¹² is preferably a single bond or an alkylene group having 2 to 3 carbons, and X is preferably a vinyl group or a (meth)acryloyl group.

In the above formula (2), R¹³ is preferably an alkyl group having 1 to 2 carbons, R¹⁴ and R¹⁵ are preferably a single bond or an alkylene group having 2 to 3 carbons, Y is preferably a vinyl group or a (meth)acryloyl group, and Z is preferably an alkyl group having 1 to 6 carbons. In addition, p is preferably 1.

Specific examples of the compound represented by the above formula (1) include vinyltrimethoxysilane, vinyltriethoxysilane, vinyltripropoxysilane, o-styryltrimethoxysilane, o-styryltriethoxysilane, m-styryltrimethoxysilane, styryltriethoxysilane, p-styryltrimethoxysilane, p-styryltriethoxysilane, allyltrimethoxysilane, allyltriethoxysilane, methacryloxytrimethoxysilane, methacryloxytriethoxysilane, methacryloxytripropoxysilane, acryloxytrimethoxysilane, acryloxytriethoxysilane, acryloxytripropoxysilane, 2-methacryloxyethyltrimethoxysilane, 2-methacryloxyethyltriethoxysilane, 2-methacryloxyethyltripropoxysilane, 3-methacryloxypropyltrimethoxysilane, 3-methacryloxypropyltriethoxysilane, 3-methacryloxypropyltripropoxysilane, 2-acryloxyethyltrimethoxysilane, 2-acryloxyethyltriethoxysilane, 2-acryloxyethyltripropoxysilane, 3-acryloxypropyltrimethoxysilane, 3-acryloxypropyltriethoxysilane, 3-acryloxypropyltripropoxysilane, 3-methacryloxypropyltrimethoxysilane, 3-methacryloxypropyltriethoxysilane, and 3-methacryloxypropyltripropoxysilane, etc. These may be used alone or as a combination of two or more thereof.

Specific examples of the compound represented by the above formula (2) include vinylmethyldimethoxysilane, vinylmethyldiethoxysilane, vinylphenyldimethoxysilane, vinylphenyldiethoxysilane, vinyldimethylmethoxysilane, vinyldimethylethoxysilane, allylmethyldimethoxysilane, allylmethyldiethoxysilane, allyldimethylmethoxysilane, allyldimethylethoxysilane, divinylmethylmethoxysilane, divinylmethylethoxysilane, 3-methacryloxypropylmethyldimethoxysilane, 3-acryloxypropylmethyldimethoxysilane, 3-methacryloxypropylphenyldimethoxysilane, 3-acryloxypropylphenylldimethoxysilane, 3,3′-dimethacryloxypropyldimethoxysilane, 3,3′-diacryloxypropyldimethoxysilane, 3,3′,3″-trimethacryloxypropylmethoxysilane, and 3,3′,3″-triacryloxypropylmethoxysilane, etc. These may be used alone or as a combination of two or more thereof.

Among the compounds represented by the above formulae (1) and (2), from the viewpoint of capability to achieve high levels of crack resistance, surface hardness and adhesiveness to a conductive pattern, etc., and the reactivity for hydrolysis-condensation, vinyltrimethoxysilane, p-styryltriethoxysilane, 3-methacryloxypropyltrimethoxysilane, 3-acryloxypropyltrimethoxysilane, 3-methacryloxypropyltriethoxysilane, 3-acryloxypropyltriethoxysilane, 3-methacryloxypropylmethyldimethoxysilane, and 3-acryloxypropylmethyldimethoxysilane, etc. are preferred.

In addition, the (b2) compound is preferably a hydrolyzable silane compound represented by the following formula (3).

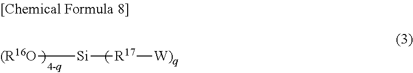

(In formula (3), R¹⁶ indicates an alkyl group having 1 to 4 carbons; R¹⁷ indicates a single bond, a methylene group or an alkylene group; W indicates a substituted or unsubstituted alkyl group having 1 to 20 carbons, a substituted or unsubstituted aryl group having 6 to 14 carbons, an amino group, a mercapto group, an epoxy group, a glycidyloxy group or a 3,4-epoxycyclohexyl group; and q is an integer of 0 to 3.)

Examples of the alkyl group for R¹⁶ are the same as those for R¹¹ in formula (1), examples of the alkyl group and the aryl group for W are the same as those for Z in formula (2), and examples of the alkylene group for R¹⁷ are the same as those for R¹⁵ in formula (2). In addition, examples of the substituent of the alkyl group and the aryl group for W are the same as the examples of the substituent of the aryl group for Z in formula (2).

R¹⁷ is preferably a single bond or an alkylene group having 2 to 3 carbons, and W is preferably a substituted or unsubstituted alkyl group having 1 to 10 carbons, a substituted or unsubstituted aryl group having 6 to 8 carbons, or a glycidyloxy group. Moreover, the substituent of the alkyl group or the aryl group is preferably a halogen atom. In addition, q is preferably 0 or 1.

Examples of the hydrolyzable silane compound represented by the above formula (3) include a silane compound having four hydrolyzable groups, a silane compound having one non-hydrolyzable group and three hydrolyzable groups, a silane compound having two non-hydrolyzable groups and two hydrolyzable groups, or a mixture thereof.

Specific examples of such hydrolyzable silane compound include: as the silane compound having four hydrolyzable groups, tetramethoxysilane, tetraethoxysilane, tetrabutoxysilane, tetraphenoxysilane, tetrabenzyloxysilane, tetra-n-propoxysilane, and tetra-i-propoxysilane, etc.;

as the silane compound having one non-hydrolyzable group and three hydrolyzable groups, methyltriimethoxysilane, methyltriethoxysilane, methyltri-i-propoxysilane, methyltributoxysilane, ethyltrimethoxysilane, ethyltriethoxysilane, ethyltri-i-propoxysilane, ethyltributoxysilane, butyltrimethoxysilane, decyltrimethoxysilane, trifluoropropyltrimethoxysilane, phenyltrimethoxysilane, phenyltriethoxysilane, aminotf ethoxysilane, aminotriethoxysilane, 3-mercaptopropyltrimethoxysilane, 2-(3,4-epoxycyclohexyl)ethyltrimethoxy, and γ-glycidoxypropyltrimethoxysilane, etc.; and
as the silane compound having two non-hydrolyzable groups and two hydrolyzable groups, dimethyldimethoxysilane, diphenyldimethoxysilane, dibutyldimethoxysilane, and 3-mercaptopropyl methyldimethoxysilane, etc., respectively. These may be used alone or as a combination of two or more thereof.

Among these hydrolyzable silane compounds, the silane compound having four hydrolyzable groups and the silane compound having one non-hydrolyzable group and three hydrolyzable groups are preferred, and the silane compound having one non-hydrolyzable group and three hydrolyzable groups is particularly preferred. Specific examples of the preferred hydrolyzable silane compounds include tetraethoxysilane, methyltrimethoxysilane, methyltriethoxysilane, methyltri-i-propoxysilane, methyltributoxysilane, phenyltrimethoxysilane, ethyltrimethoxysilane, ethyltriethoxysilane, ethyltriisopropoxysilane, ethyltributoxysilane, butyltrimethoxysilane, γ-glycidoxypropyltrimethoxysilane, decyltrimethoxysilane, and trifluoropropyltrimethoxysilane.

The proportion of the (b1) compound in the siloxane polymer (b) obtained by the cohydrolysis-condensation reaction between the (b1) compound and the (b2) compound exceeds 15 mol %, and is preferably 16 mol % or more, particularly preferably 18 mol % or more. When the proportion of the (b1) compound is 15 mol % or less, exposure sensitivity is reduced, and heat resistance, adhesiveness and resolution of the obtained cured film are reduced. Moreover, the upper limit of the proportion of the (b1) compound in the siloxane polymer (b) is preferably 50 mol %, more preferably 40 mol % and particularly preferably 30 mol % from the viewpoint of crack resistance, heat resistance and adhesiveness.

Conditions for cohydrolysis-condensation between the (b1) compound and the (b2) compound are not particularly limited as long as at least a portion of the (b1) compound and the (b2) compound is hydrolyzed so as to convert a hydrolyzable group to a silanol group to cause a condensation reaction, and the following method can be mentioned as an example.

A method of mixing the (b1) compound with the (b2) compound in a solvent and adding water to the mixed solution to perform hydrolysis-condensation is preferably adopted.

In that case, the water used in the cohydrolysis-condensation reaction between the (b1) compound and the (b2) compound is preferably water purified by methods such as a reverse osmosis membrane treatment, an ion exchange treatment, and distillation, etc. By using such purified water, side reaction is suppressed, and reactivity for hydrolysis can be enhanced. The amount of the water used is preferably 0.1 mol to 3 mol, more preferably 0.3 mol to 2 mol, and even more preferably 0.5 mol to 1.5 mol, with respect to a total amount of 1 mol of the hydrolyzable group in the (b1) compound and the (b2) compound. By using the water in such an amount, a reaction rate of hydrolysis-condensation can be optimized.

The solvent used in the cohydrolysis-condensation reaction between the (b1) compound and the (b2) compound is not particularly limited. Generally, the same solvent as that used for preparing the later-described radiation-sensitive resin composition can be used. Preferred examples of such solvent include an ethylene glycol monoalkyl ether acetate, a diethylene glycol dialkyl ether, a propylene glycol monoalkyl ether, a propylene glycol monoalkyl ether acetate, and propionate esters.

These solvents may be used alone or as a combination of two or more thereof. Among these solvents, a diethylene glycol dimethyl ether, a diethylene glycol ethyl methyl ether, a propylene glycol monomethyl ether, a propylene glycol monoethyl ether, a propylene glycol monomethyl ether acetate, or methyl 3-methoxypropionate are particularly preferred.

The cohydrolysis-condensation reaction between the (b1) compound and the (b2) compound is preferably performed in the presence of a catalyst such as an acid catalyst (e.g., hydrochloric acid, sulfuric acid, nitric acid, formic acid, oxalic acid, acetic acid, trifluoroacetic acid, trifluoromethanesulfonic acid, phosphoric acid, acidic ion-exchange resin, and various Lewis acids), a base catalyst (e.g., a nitrogen-containing compound such as ammonia, primary amines, secondary amines, tertiary amines, and pyridine, etc.; a basic ion-exchange resin; a hydroxide such as sodium hydroxide, etc.; a carbonate such as potassium carbonate, etc.; a carboxylate such as sodium acetate, etc.; and various Lewis bases), or an alkoxide (e.g., zirconium alkoxide, titanium alkoxide, and aluminum alkoxide), etc. Examples of the aluminum alkoxide include tri-i-propoxyaluminum. From the viewpoint of accelerating the hydrolysis-condensation reaction, the amount of the catalyst used is preferably 0.2 mol or less, more preferably 0.00001 mol to 0.1 mol, with respect to a total amount of 1 mol of the (b1) compound and the (b2) compound.

The reaction temperature and reaction time in the cohydrolysis-condensation reaction between the (b1) compound and the (b2) compound can be properly set. For example, the following conditions can be adopted. The reaction temperature is preferably 40° C. to 200° C., more preferably 50° C. to 150° C. The reaction time is preferably 30 minutes to 24 hours, more preferably 1 hour to 12 hours. By having such reaction temperature and reaction time, the hydrolysis-condensation reaction can be performed most efficiently.

In this hydrolysis-condensation reaction, the hydrolyzable silane compound, the water and the catalyst may be added into the reaction system at a time to perform the reaction in one step, or may be added into the reaction system in several separate operations to perform the hydrolysis reaction and the condensation reaction in multiple steps. Moreover, after the hydrolysis-condensation reaction, by addition of a dehydrating agent followed by evaporation, water and generated alcohol can be removed from the reaction system. Generally, the dehydrating agent used in this step absorbs or includes excessive water so that its dehydration ability is completely consumed, or is removed by evaporation.

The molecular weight of the siloxane polymer (b) obtained by the hydrolysis-condensation reaction can be measured as a polystyrene-converted weight average molecular weight using gel permeation chromatography (GPC) that uses tetrahydrofuran as the mobile phase. The weight average molecular weight (Mw) of the siloxane polymer (b) is preferably within a range of 500 to 10000, more preferably within a range of 1000 to 5000. By adjusting the value of the weight average molecular weight of the siloxane polymer (b) to 500 or greater, coating film formation properties of the radiation-sensitive resin composition that contains the siloxane polymer (b) can be improved. Meanwhile, by adjusting the weight average molecular weight to 10000 or less, reduction in alkali developability of the radiation-sensitive resin composition that contains the siloxane polymer (b) can be prevented.

In addition, a ratio between the weight average molecular weight (Mw) and a number average molecular weight (Mn) measured under the same conditions, i.e., a dispersion degree (Mw/Mn), is preferably 1.0 to 15.0, more preferably 1.1 to 10.0, and even more preferably 1.1 to 5.0. By adjusting the ratio within such a range, alkali developability, adhesiveness and crack resistance can all be achieved.

[Siloxane Polymer (b-II)]

A siloxane polymer (b-II) is a polysiloxane obtained by hydrolysis-condensation of a silane compound having no radically polymerizable organic group. By using the siloxane polymer (b) and the siloxane polymer (b-II) in combination, the cured film formed from the radiation-sensitive resin composition that contains the siloxane polymer (b) and the siloxane polymer (b-II) as the [A] polymer is capable of achieving high levels of crack resistance, heat resistance, adhesiveness and resolution as compared to the case where only the siloxane polymer (b) is used.

The siloxane polymer (b-II) can be obtained by (co)hydrolysis-condensation of at least one of the hydrolyzable silane compounds represented by the above formula (3) under the same conditions as those for the siloxane polymer (b).

The weight average molecular weight (Mw) of the siloxane polymer (b-II) obtained by the hydrolysis-condensation reaction can be measured under the same conditions as those for the siloxane polymer (b), and is preferably 500 to 10000, more preferably 1000 to 5000, from the viewpoint of coating film formation properties and developability.

In addition, the ratio between the weight average molecular weight (Mw) and the number average molecular weight (Mn) measured under the same conditions, i.e., the dispersion degree (Mw/Mn), is preferably 1.0 to 15.0, more preferably 1.1 to 10.0, and even more preferably 1.1 to 5.0, from the viewpoint of alkali developability, adhesiveness and crack resistance.

A use ratio of the siloxane polymer (b) and the siloxane polymer (b-II) is preferably properly adjusted so that the content of the radically polymerizable organic group in bonding groups on total Si atoms in the siloxane polymer (b) and the siloxane polymer (b-II) reaches 1 mol % to 20 mol %, more preferably 5 mol % to 18 mol %, and particularly preferably 10 mol % to 15 mol %. By adjusting the use ratio of the siloxane polymer (b) and the siloxane polymer (b-II) within the above range, the cured film formed from the radiation-sensitive resin composition that contains the siloxane polymer (b) and the siloxane polymer (b-II) as the [A] polymer is capable of achieving high levels of adhesiveness, crack resistance, heat resistance, and abrasion resistance.

Moreover, when the radiation-sensitive resin composition of the present embodiment contains a siloxane-based polymer as the [A] polymer, since the radically polymerizable organic group is contained in the above proportion, the radiation-sensitive resin composition can have radiation sensitivity.

In addition, qualitative analysis and quantitative analysis of the radically polymerizable organic group in the polysiloxane are enabled by ¹H-NMR, ¹³C-NMR, FT-IR and pyrolysis-gas chromatography-mass spectrometry.

(Epoxy Resin)

Examples of an epoxy resin (c) that can be used as the [A] polymer in the radiation-sensitive resin composition of the present embodiment include: an epoxy resin of phenol novolac type, cresol novolac type, bisphenol A type, bisphenol F type, hydrogenated bisphenol A type, hydrogenated bisphenol F type, bisphenol S type, trisphenolmethane type, tetraphenolethane type, bixylenol type or biphenol type; an alicyclic or heterocyclic epoxy resin; and an epoxy resin having a dicyclopentadiene or naphthalene structure.

The radiation-sensitive resin composition of the present embodiment that contains the epoxy resin (c) is capable of forming a cured film excellent in adhesiveness to various substrates such as a glass substrate or a resin substrate, etc.

Moreover, the epoxy resin (c) in the invention does not contain an acrylic polymer having a structural unit derived from a monomer containing an epoxy group by glycidyl methacrylate and so on that is explained in the section “[Structural Unit (a2)].”

Various commercial products can be used as the epoxy resin (c). Examples thereof include: a bisphenol A-type epoxy resin, such as TECHMORE® VG3101L (trade name; made by Mitsui Chemicals, Inc.), Epikote 828, Epikote 834, Epikote 1001 and Epikote 1004 (trade names; made by JER Co., Ltd.), Epiclon 840, Epiclon 850, Epiclon 1050 and Epiclon 2055 (trade names; made by DIC Corporation), Epo Tohto YD-011, Epo Tohto YD-013, Epo Tohto YD-127 and Epo Tohto YD-128 (trade names; made by Tohto Kasei Co., Ltd.), D.E.R. 317, D.E.R. 331, D.E.R. 661 and D.E.R. 664 (trade names; made by The DOW Chemical Company), Araldide 6071, Araldide 6084, Araldide GY250 and Araldide GY260 (trade names; made by Chiba Specialty Chemicals Co. Ltd.), Sumi-Epoxy ESA-011, Sumi-Epoxy ESA-014, Sumi-Epoxy ELA-115 and Sumi-Epoxy ELA-128 (trade names; made by Sumitomo Chemical Co., Ltd.), A.E.R. 330, A.E.R. 331, A.E.R. 661 and A.E.R. 664 (trade names; made by Asahi Kasei E-materials Corporation), etc.;
a novolac type epoxy resin, such as Epikote 152 and Epikote 154 (trade names; made by JER Co., Ltd.), D.E.R. 431 and D.E.R. 438 (trade names; made by The DOW Chemical Company), Epiclon N-730, Epiclon N-770 and Epiclon N-865 (trade names; made by DIC Corporation), Epo Tohto YDCN-701 and Epo Tohto YDCN-704 (trade names; made by Tohto Kasei Co., Ltd.), Araldide ECN1235, Araldide ECN1273 and Araldide ECN1299 (trade names; made by Chiba Specialty Chemicals Co. Ltd.), XPY307, EPPN®-201, EOCN®-1025, EOCN®-1020, EOCN®-104S and RE-306 (trade names; made by Nippon Kayaku Co., Ltd.), Sumi-Epoxy ESCN-195X and Sumi-Epoxy ESCN-220 (trade names; made by Sumitomo Chemical Co., Ltd.), A.E.R. ECN-235 and A.E.R. ECN-299 (trade names; made by ADEKA Corporation), etc.;
a bisphenol F-type epoxy resin, such as Epiclon 830 (trade name; made by DIC Corporation), JER® 807 (trade names; made by JER Co., Ltd.), Epo Tohto YDF-170 (trade name; made by Tohto Kasei Co., Ltd.), YDF-175, YDF-2001, YDF-2004, and Araldide XPY306 (trade name; made by Chiba Specialty Chemicals Co. Ltd.), etc.; a hydrogenated bisphenol A-type epoxy resin, such as Epo Tohto ST-2004, Epo Tohto ST-2007 and Epo Tohto ST-3000 (trade names; made by Tohto Kasei Co., Ltd.), etc.;
an alicyclic epoxy resin, such as CELLOXIDE® 2021 (trade name; made by Daicel Chemical Industries, Ltd.), Araldide CY175, Araldide CY179 and Araldide CY184 (trade names; made by Chiba Specialty Chemicals Co. Ltd.), etc.;
a trihydroxyphenyl methane-type epoxy resin, such as YL-933 (trade name; made by JER Co., Ltd.), EPPN®-501 and EPPN®-502 (trade names; made by The DOW Chemical Company), etc.; a bixylenol type or biphenol type epoxy resin or a mixture thereof, such as YL-6056, YX-4000 and YL-6121 (trade names; made by JER Co., Ltd.), etc.;
a bisphenol S-type epoxy resin, such as EBPS-200 (trade name; made by Nippon Kayaku Co., Ltd.), EPX-30 (trade name; made by ADEKA Corporation), EXA-1514 (trade name; made by DIC Corporation), etc.; a bisphenol A novolac-type epoxy resin, such as JER® 157S (trade name; made by JER Co., Ltd.), etc.; a tetraphenylol ethane-type epoxy resin, such as YL-931 (trade name; made by JER Co., Ltd.), Araldide 163 (trade name; made by Chiba Specialty Chemicals Co. Ltd.), etc.;
a heterocyclic epoxy resin, such as Araldide PT810 (trade name; made by Chiba Specialty Chemicals Co. Ltd.), TEPIC® (trade name; made by Nissan Chemical Industries, Limited), etc.; a naphthalene-containing epoxy resin, such as HP-4032, EXA-4750 and EXA-4700 (trade names; made by DIC Corporation), etc.; and an epoxy resin having a dicyclopentadiene skeleton, such as HP-7200, HP-7200H and HP-7200HH (trade names; made by DIC Corporation), etc.

Among these epoxy resins (c), from the viewpoint of curability, aromatic epoxy resins such as phenol novolac-type epoxy resin, cresol novolac-type epoxy resin, bisphenol A-type epoxy resin and bisphenol F-type epoxy resin, etc. are preferred.

In addition, the epoxy group in the epoxy resin is reacted with a (meth)acryloyl group-containing monocarboxylic acid to perform ring opening of the epoxy group to form a hydroxyl group. A modified epoxy resin having an epoxy group obtained by reacting part of the hydroxyl group with a polycarboxylic acid or polycarboxylic anhydride, and also a carboxyl group and a (meth)acryloyl group, can be used. Moreover, the term “modified epoxy resin” means an epoxy resin in which some of the epoxy groups are modified into carboxyl groups or (meth)acryloyl groups.

By modifying some of the epoxy groups in such epoxy resin into carboxyl groups or (meth)acryloyl groups, alkali solubility can be imparted by the carboxyl group, and radical polymerizability can be imparted by the (meth)acryloyl group.

Examples of the (meth)acryloyl group-containing monocarboxylic acid include methacrylic acid, and acrylic acid, etc.

Examples of the polycarboxylic acid and polycarboxylic anhydride include: an aliphatic saturated polycarboxylic acid, such as oxalic acid, succinic acid, phthalic acid, adipic acid, dodecanedioic acid, dodecenyl succinic acid, pentadecenyl succinic acid and octadecenyl succinic acid, etc.; an aromatic polycarboxylic acid such as tetrahydrophthalic acid, hexahydrophthalic acid, methyltetrahydrophthalic acid, trimellitic acid, pyromellitic acid, biphenyltetracarboxylic acid and naphthalene tetracarboxylic acid, etc. and an anhydride thereof (e.g., an aliphatic saturated polycarboxylic anhydride such as succinic anhydride, dodecenyl succinic anhydride, pentadecenyl succinic anhydride and octadecenyl succinic anhydride, etc.; and an aromatic polycarboxylic anhydride, such as phthalic anhydride, tetrahydrophthalic anhydride, hexahydrophthalic anhydride, methyltetrahydrophthalic anhydride, trimellitic anhydride, pyromellitic dianhydride, biphenyltetracarboxylic anhydride and naphthalenetetracarboxylic anhydride, etc.).

Among the above, from the viewpoint of reactivity and developability, the saturated polycarboxylic anhydrides are preferred.

The temperature of the reaction between the (meth)acryloyl group-containing monocarboxylic acid and the epoxy group in the epoxy resin is not particularly limited, and is preferably 70° C. to 110° C. In addition, the reaction time is not particularly limited, and is preferably 5 hours to 30 hours. In addition, e.g., a catalyst such as triphenylphosphine or the like and a radical polymerization inhibitor such as hydroquinone or p-methoxyphenol or the like, may also be used, if necessary.

In addition, an equivalent weight of the polycarboxylic acid or polycarboxylic anhydride to be prepared with respect to a weight of a (meth)acrylic acid adduct preferably results in an acid value of the obtained resin of preferably 10 mgKOH/g to 500 mgKOH/g.

The reaction temperature of the reaction between the (meth)acrylic acid adduct and the polycarboxylic acid or polycarboxylic anhydride is not particularly limited, and is preferably 70° C. to 110° C. In addition, the reaction time is not particularly limited, and is preferably 3 hours to 10 hours.

<[B] Photosensitizer>

Examples of the [B] photosensitizer contained in the radiation-sensitive resin composition of the second embodiment of the invention include a compound (i.e., [B-1] photo-radical polymerization initiator) capable of responding to radiation to generate radicals so as to initialize polymerization, a compound (i.e., [B-2] photoacid generator) responding to radiation to generate an acid, or a compound (i.e., [B-3] photobase generator) responding to radiation to generate a base.

Examples of such [B-1] photo-radical polymerization initiator include an O-acyloxime compound, an acetophenone compound, and a biimidazole compound, etc. These compounds may be used alone or as a mixture of two or more thereof.

Examples of the O-acyloxime compound include 1,2-octanedione 1-[4-(phenylthio)-2-(O-benzoyloxime)], ethanone-1-[9-ethyl-6-(2-methylbenzoyl)-9H-carbazol-3-yl]-1-(O-acetyloxime), 1-(9-ethyl-6-benzoyl-9.H.-carbazol-3-yl)-octan-1-oneoxime-O-acetate, 1-[9-ethyl-6-(2-methylbenzoyl)-9.H.-carbazol-3-yl]-ethan-1-oneoxime-O-benzoate, 1-[9-n-butyl-6-(2-ethylbenzoyl)-9.H. -carbazol-3-yl]-ethan-1-oneoxime-O-benzoate, ethanone-1-[9-ethyl-6-(2-methyl-4-tetrahydrofuranylbenzoyl)-9.H.-carbazol-3-yl]-1-(O-acetyloxime), ethanone-1-[9-ethyl-6-(2-methyl-4-tetrahydropyranylbenzoyl)-9.H. -carbazol-3-yl]-1-(O-acetyloxime), ethanone-1-[9-ethyl-6-(2-methyl-5-tetrahydrofuranylbenzoyl)-9.H.-carbazol-3-yl]-1-(O-acetyloxime), and ethanone-1-[9-ethyl-6-{2-methyl-4-(2,2-dimethyl-1,3-dioxolanyl)methoxybenzoyl}-9.H.-carbazol-3-yl]-1-(O-acetyloxime), etc.

Among them, 1,2-octanedione 1-[4-(phenylthio)-2-(O-benzoyloxime)], ethanone-1-[9-ethyl-6-(2-methylbenzoyl)-9H-carbazol-3-yl]-1-(O-acetyloxime), ethanone-1-[9-ethyl-6-(2-methyl-4-tetrahydrofuranylbenzoyl)-9.H.-carbazol-3-yl]-1-(O-acetyloxime) or ethanone-1-[9-ethyl-6-{2-methyl-4-(2,2-dimethyl-1,3-dioxolanyl)methoxybenzoyl}-9.H.-carbazol-3-yl]-1-(O-acetyloxime) is preferred.

Examples of the acetophenone compound include an α-aminoketone compound and an α-hydroxyketone compound.

Examples of the α-aminoketone compound include 2-benzyl-2-dimethylamino-1-(4-morpholinophenyl)-butan-1-one, 2-dimethylamino-2-(4-methylbenzyl)-1-(4-morpholin-4-yl-phenyl)-butan-1-one, and 2-methyl-1-(4-methylthiophenyl)-2-morpholinopropan-1-one, etc.

Examples of the α-hydroxyketone compound include 1-phenyl-2-hydroxy-2-methylpropan-1-one, 1-(4-i-propylphenyl)-2-hydroxy-2-methylpropan-1-one, 4-(2-hydroxyethoxy)phenyl-(2-hydroxy-2-propyl)ketone, and 1-hydroxycyclohexyl phenyl ketone, etc.

The acetophenone compound is preferably an α-aminoketone compound, and is particularly preferably 2-benzyl-2-dimethylamino-1-(4-morpholinophenyl)-butan-1-one, 2-dimethylamino-2-(4-methylbenzyl)-1-(4-morpholin-4-yl-phenyl)-butan-1-one, or 2-methyl-1-(4-methylthiophenyl)-2-morpholinopropan-1-one.

The biimidazole compound is preferably, e.g., 2,2′-bis(2-chlorophenyl)-4,4′,5,5′-tetraphenyl-1,2′-biimidazole, 2,2′-bis(2,4-dichlorophenyl)-4,4′,5,5′-tetraphenyl-1,2′-biimidazole or 2,2′-bis(2,4,6-trichlorophenyl)-4,4′,5,5′-tetraphenyl-1,2′-biimidazole. Among them, 2,2′-bis(2,4-dichlorophenyl)-4,4′,5,5′-tetraphenyl-1,2′-biimidazole is more preferred.

As described above, the [B-1] photo-radical polymerization initiator can be used alone or as a mixture of two or more thereof. A content ratio of the [B-1] photo-radical polymerization initiator is preferably 1 mass part to 40 mass parts, more preferably 5 mass parts to 30 mass parts, with respect to 100 mass parts of the [A] polymer. By adjusting a use ratio of the [B-1] photo-radical polymerization initiator to 1 mass part to 40 mass parts, the radiation-sensitive resin composition is capable of forming a cured film having high solvent resistance, high hardness and high adhesiveness even in a low exposure amount.

Next, examples of the [B-2] photoacid generator as the [B] photosensitizer in the radiation-sensitive resin composition of the present embodiment include an oxime sulfonate compound, an onium salt, a sulfonimide compound, a halogen-containing compound, a diazomethane compound, a sulfone compound, a sulfonate compound, a carboxylate compound, and a quinonediazide compound, etc. Moreover, these [B-2] photoacid generators may be used alone or as a mixture of two or more thereof.

The oxime sulfonate compound is preferably a compound containing an oxime sulfonate group represented by the following formula (B 1).

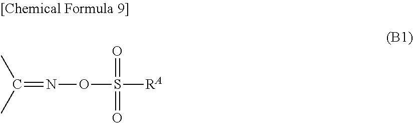

In the above formula (B1), R^{A} is an alkyl group having 1 to 12 carbons, a fluoroalkyl group having 1 to 12 carbons, an alicyclic hydrocarbon group having 4 to 12 carbons, an aryl group having 6 to 20 carbons, or a group obtained by replacing some or all of the hydrogen atoms in the alkyl group, the aliphatic hydrocarbon group and the aryl group with substituents.

The alkyl group represented by R^{A} in the above formula (B1) is preferably a linear or branched alkyl group having 1 to 12 carbons. This linear or branched alkyl group having 1 to 12 carbons may be replaced with a substituent, and examples of the substituent include an alkoxy group having 1 to 10 carbons, and an alicyclic group including a bridged alicyclic group such as 7,7-dimethyl-2-oxonorbornyl group, etc. Examples of the fluoroalkyl group having 1 to 12 carbons include a trifluoromethyl group, a pentafluoroethyl group, and a heptylfluoropropyl group, etc.

The alicyclic hydrocarbon group represented by R^{A} is preferably an alicyclic hydrocarbon group having 4 to 12 carbons. This alicyclic hydrocarbon group having 4 to 12 carbons may be replaced with a substituent, and examples of the substituent include an alkyl group having 1 to 5 carbons, an alkoxy group, and a halogen atom, etc.

The aryl group represented by R^{A} is preferably an aryl group having 6 to 20 carbons, and is more preferably a phenyl group, a naphthyl group, a tolyl group, or a xylyl group. The aryl group may be replaced with a substituent, and examples of the substituent include an alkyl group having 1 to 5 carbons, an alkoxy group, and a halogen atom, etc.

Examples of the oxime sulfonate compound include (5-propylsulfonyloxyimino-5H-thiophen-2-ylidene)-(2-methylphenyl)acetonitrile, (5-octylsulfonyloxyimino-5H-thiophen-2-ylidene)-(2-methylphenyl)acetonitrile, (camphorsulfonyloxyimino-5H-thiophen-2-ylidene)-(2-methylphenyl)acetonitrile, (5-p-toluenesulfonyloxyimino-5H-thiophen-2-ylidene)-(2-methylphenyl)acetonitrile, and (5-octylsulfonyloxyimino)-(4-methoxyphenyl)acetonitrile, etc.

By using the aforementioned oxime sulfonate compound as the [B-2] photoacid generator, the obtained radiation-sensitive resin composition of the present embodiment can be enhanced in sensitivity and solubility.

Examples of the onium salt include diphenyliodonium salt, triphenylsulfonium salt, sulfonium salt, benzothiazonium salt, and tetrahydrothiophenium salt, etc.

The onium salt is preferably tetrahydrothiophenium salt or benzylsulfonium salt, more preferably 4,7-di-n-butoxy-1-naphthyltetrahydrothiophenium trifluoromethanesulfonate or benzyl-4-hydroxyphenylmethylsulfonium hexafluorophosphate, and even more preferably 4,7-di-n-butoxy-1-naphthyltetrahydrothiophenium trifluoromethanesulfonate.

By using the aforementioned onium salt as the [B-2] photoacid generator, the obtained radiation-sensitive resin composition of the present embodiment can be enhanced in sensitivity and solubility.

Examples of the sulfonimide compound include N-(trifluoromethylsulfonyloxy)succinimide, N-(camphorsulfonyloxy)succinimide, N-(4-methylphenylsulfonyloxy)succinimide, N-(2-trifluoromethylphenylsulfonyloxy)succinimide, N-(4-fluorophenylsulfonyloxy)succinimide, N-(trifluoromethylsulfonyloxy)phthalimide, N-(camphorsulfonyloxy)phthalimide, N-(2-trifluoromethylphenylsulfonyloxy)phthalimide, N-(2-fluorophenylsulfonyloxy)phthalimide, N-(trifluoromethylsulfonyloxy)diphenylmaleimide, N-(camphorsulfonyloxy)diphenylmaleimide, and N-(4-methylphenylsulfonyloxy)diphenylmaleimide, etc.

By using the aforementioned sulfonimide compound as the [B-2] photoacid generator, the obtained radiation-sensitive resin composition of the present embodiment can be enhanced in sensitivity and solubility.

The sulfonate compound is preferably haloalkylsulfonate, more preferably N-hydroxynaphthalimide-trifluoromethanesul fonate.

By using the aforementioned sulfonate compound as the [B-2] photoacid generator, the obtained radiation-sensitive resin composition of the present embodiment can be enhanced in sensitivity and solubility.

In addition, as described above, the radiation-sensitive resin composition of the second embodiment of the invention can contain a quinonediazide compound as the [B-2] photoacid generator as the [B] photosensitizer. By containing a quinonediazide compound, the radiation-sensitive resin composition of the present embodiment can be used as a positive radiation-sensitive resin composition. Also, the radiation-sensitive resin composition is capable of imparting a light shielding property to the formed cured film. Furthermore, due to a photobleaching property, transmissivity of the formed cured film for light in a visible light region can also be adjusted.

The quinonediazide compound that can be used as the [B-2] photoacid generator is a quinonediazide compound that generates a carboxylic acid due to irradiation with radiation. The quinonediazide compound may be a condensate of a phenolic compound or alcoholic compound (hereinafter called “mother nucleus”) and a 1,2-naphthoquinonediazide sulfonic acid halide.

Examples of the mother nucleus include trihydroxybenzophenone, tetrahydroxybenzophenone, pentahydroxybenzophenone, hexahydroxybenzophenone, (polyhydroxyphenyl)alkane, and other mother nucleus, etc.

Examples of the trihydroxybenzophenone include 2,3,4-trihydroxybenzophenone and 2,4,6-trihydroxybenzophenone, etc.

Examples of the tetrahydroxybenzophenone include 2,2′,4,4′-tetrahydroxybenzophenone, 2,3,4,3′-tetrahydroxybenzophenone, 2,3,4,4′-tetrahydroxybenzophenone, 2,3,4,2′-tetrahydroxy-4′-methylbenzophenone, and 2,3,4,4′-tetrahydroxy-3′-ethoxybenzophenone, etc.

Examples of the pentahydroxybenzophenone include 2,3,4,2′,6′-pentahydroxybenzophenone, etc.

Examples of the hexahydroxybenzophenone include 2,4,6,3′,4′,5′-hexahydroxybenzophenone and 3,4,5,3′,4′,5′-hexahydroxybenzophenone, etc.

Examples of the (polyhydroxyphenyl)alkane include bis(2,4-dihydroxyphenyl)methane, bis(p-hydroxyphenyl)methane, tris(p-hydroxyphenyl)methane, 1,1,1-tris(p-hydroxyphenyl)ethane, bis(2,3,4-trihydroxyphenyl)methane, 2,2-bis(2,3,4-trihydroxyphenyl)propane, 1,1,3-tris(2,5-dimethyl-4-hydroxyphenyl)-3-phenyl propane, 4,4′-[1-{4-(1-[4-hydroxyphenyl]-1-methylethyl)phenyl}ethylidene]bisphenol, bis(2,5-dimethyl-4-hydroxyphenyl)-2-hydroxyphenylmethane, 3,3,3′,3′-tetramethyl-1,1′-spirobiindene-5,6,7,5′,6′,7′-hexanol, and 2,2,4-trimethyl-7,2′,4′-trihydroxyflavan, etc.

Examples of the other mother nucleus include 2-methyl-2-(2,4-dihydroxyphenyl)-4-(4-hydroxyphenyl)-7-hydroxychroman, 1-[1-{3-(1-[4-hydroxyphenyl]-1-methylethyl)-4,6-dihydroxyphenyl}-1-methylethyl]-3-[1-{3-(1-[4-hydroxyphenyl]-1-methylethyl)-4,6-dihydroxyphenyl}-1-methylethyl]benzene, and 4,6-bis{1-(4-hydroxyphenyl)-1-methylethyl}-1,3-dihydroxybenzene, etc.

Among these mother nuclei, 2,3,4,4′-tetrahydroxybenzophenone, 1,1,1-tris(p-hydroxyphenyl)ethane, and 4,4′-[1-{4-(1-[4-hydroxyphenyl]-1-methylethyl)phenyl}ethylidene]bisphenol are preferably used.

The 1,2-naphthoquinonediazide sulfonic acid halide is preferably 1,2-naphthoquinonediazide sulfonic acid chloride. Examples of the 1,2-naphthoquinonediazide sulfonic acid chloride include 1,2-naphthoquinonediazide-4-sulfonic acid chloride and 1,2-naphthoquinonediazide-5-sulfonic acid chloride, etc. Among them, 1,2-naphthoquinonediazide-5-sulfonic acid chloride is more preferred.

In a condensation reaction between the phenolic compound or alcoholic compound (mother nucleus) and the 1,2-naphthoquinonediazide sulfonic acid halide, the 1,2-naphthoquinonediazide sulfonic acid halide corresponding to preferably 30 mol % to 85 mol %, more preferably 50 mol % to 70 mol % with respect to the number of OH groups in the phenolic compound or alcoholic compound can be used. The condensation reaction can be carried out by a well-known method.

In addition, as the quinonediazide compound, 1,2-naphthoquinonediazide sulfonic acid amides in which an ester bond in the mother nucleus exemplified above is changed to an amide bond, such as 2,3,4-triaminobenzophenone-1,2-naphthoquinonediazide-4-sulfonic acid amide, etc., are also suitably used.

These quinonediazide compounds can be used alone or as a combination of two or more thereof.

A use ratio of the quinonediazide compound in the radiation-sensitive resin composition of the present embodiment can be adjusted to a later-described range. By doing so, a difference in solubility in alkali aqueous solution as a developer between a radiation-irradiated part and an unirradiated part is enlarged, so that patterning performance can be enhanced. In addition, the solvent resistance of a cured film obtained using this radiation-sensitive resin composition can also be improved.

With regard to the above [B-2] photoacid generators, the oxime sulfonate compound, the onium salt, the sulfonimide compound and the quinonediazide compound are preferred, and the oxime sulfonate compound is more preferred.

The content of the [B-2] photoacid generator is preferably 0.1 mass part to 10 mass parts, more preferably 1 mass part to 5 mass parts, with respect to 100 mass parts of the [A] polymer component. By adjusting the content of the [B-2] photoacid generator to the above range, the sensitivity of the radiation-sensitive resin composition of the present embodiment is optimized, and a cured film having high surface hardness can be formed.

Next, the [B-3] photobase generator as the [B] photosensitizer in the radiation-sensitive resin composition of the present embodiment is not particularly limited as long as being a compound that generates a base (such as an amine, etc.) due to irradiation with radiation. Examples of the [B-3] photobase generator include a transition metal complex such as cobalt, etc., ortho-nitrobenzyl carbamates, α,α-dimethyl-3,5-dimethoxybenzyl carbamates, and acyloxyiminos, etc.

Examples of the transition metal complex include bromopentaammoniacobalt perchlorate, bromopentamethylaminecobalt perchlorate, bromopentapropylaminecobalt perchlorate, hexaammoniacobalt perchlorate, hexamethylaminecobalt perchlorate, and hexapropylaminecobalt perchlorate, etc.

Examples of the ortho-nitrobenzyl carbamates include [[(2-nitrobenzyl)oxy]carbonyl]methylamine, [[(2-nitrobenzyl)oxy]carbonyl]propylamine, [[(2-nitrobenzyl)oxy]carbonyl]hexylamine, [[(2-nitrobenzyl)oxy]carbonyl]cyclohexylamine, [[(2-nitrobenzyl)oxy]carbonyl]aniline, [[(2-nitrobenzyl)oxy]carbonyl]piperidine, bis[[(2-nitrobenzyl)oxy]carbonyl]hexamethylenediamine, bis[[(2-nitrobenzyl)oxy]carbonyl]phenylenediamine, bis[[(2-nitrobenzyl)oxy]carbonyl]toluenediamine, bis[[(2-nitrobenzyl)oxy]carbonyl]diaminodiphenylmethane, bis[[(2-nitrobenzyl)oxy]carbonyl]piperazine, [[(2,6-dinitrobenzyl)oxy]carbonyl]methylamine, [[(2,6-dinitrobenzyl)oxy]carbonyl]propylamine, [[(2,6-dinitrobenzyl)oxy]carbonyl]hexylamine, [[(2,6-dinitrobenzyl)oxy]carbonyl]cyclohexylamine, [[(2,6-dinitrobenzyl)oxy]carbonyl]aniline, [[(2,6-dinitrobenzyl)oxy]carbonyl]piperidine, bis[[(2,6-dinitrobenzyl)oxy]carbonyl]hexamethylenediamine, bis[[(2,6-dinitrobenzyl)oxy]carbonyl]phenylenediamine, bis[[(2,6-dinitrobenzyl)oxy]carbonyl]toluenediamine, bis[[(2,6-dinitrobenzyl)oxy]carbonyl]diaminodiphenylmethane, and bis[[(2,6-dinitrobenzyl)oxy]carbonyl]piperazine, etc.

Examples of the α,α-dimethyl-3,5-dimethoxybenzyl carbamates include [[(α,α-dimethyl-3,5-dimethoxybenzyl)oxy]carbonyl]methylamine, [[(α,α-dimethyl-3,5-dimethoxybenzyl)oxy]carbonyl]propylamine, [[(α,α-dimethyl-3,5-dimethoxybenzyl)oxy]carbonyl]hexylamine, [[(α,α-dimethyl-3,5-dimethoxybenzyl)oxy]carbonyl]cyclohexylamine, [[α,α-dimethyl-3,5-dimethoxybenzyl)oxy]carbonyl]aniline, [[(α,α-dimethyl-3,5-dimethoxybenzyl)oxy]carbonyl]piperidine, bis[[(α,α-dimethyl-3,5-dimethoxybenzyl)oxy]carbonyl]hexamethylenediamine, bis[[(α,α-dimethyl-3,5-dimethoxybenzyl)oxy]carbonyl]phenylenediamine, bis[[α,α-dimethyl-3,5-dimethoxybenzyl)oxy]carbonyl]toluenediamine, bis[[(α,α-dimethyl-3,5-dimethoxybenzyl)oxy]carbonyl]diaminodiphenylmethane, and bis[[(α,α-dimethyl-3,5-dimethoxybenzyl)oxy]carbonyl]piperadine, etc.

Examples of the acyloxyiminos include propionyl acetophenone oxime, propionyl benzophenone oxime, propionyl acetone oxime, butyryl acetophenone oxime, butyryl benzophenone oxime, butyryl acetone oxime, adipoyl acetophenone oxime, adipoyl benzophenone oxime, adipoyl acetone oxime, acroyl acetophenone oxime, acroyl benzophenone oxime, and acroyl acetone oxime, etc.

As the other examples of the [B-3] photobase generator, 2-nitrobenzylcyclohexyl carbamate, O-carbamoyl hydroxyamide and O-carbamoyl hydroxyamide are particularly preferred.

The [B-3] photobase generator may be used alone or as a mixture of two or more thereof. In addition, the [B-3] photobase generator and the [B-2] photoacid generator may be used in combination as long as the effects of the invention are not impaired.

When the [B-3] photobase generator is used, the content thereof is preferably 0.1 mass part to 20 mass parts, more preferably 1 mass part to 10 mass parts, with respect to 100 mass parts of the [A] polymer. By adjusting the content of the [B-3] photobase generator to 0.1 mass part to 20 mass parts, a radiation-sensitive resin composition can be obtained having an excellent balance between melt flow resistance and heat resistance of the fanned cured film. In addition, formation of precipitates in the forming step of the coating film is prevented, and formation of the coating film can be facilitated.

<[C] Compound>

The radiation-sensitive resin composition of the second embodiment of the invention can further contain, in addition to the aforementioned [A] component and [B] component, the [C] compound ([C] component) functioning as a curing accelerator.

By containing the [C] compound functioning as the curing accelerator, the radiation-sensitive resin composition of the second embodiment of the invention is capable of realizing a more sufficient curing reaction when forming a cured film that serves as the interlayer insulating film. That is, hardness of the cured film is increased, unreacted components remaining in the cured film are reduced, and the phenomenon that the cured film or the unreacted component, after the cured film is formed, e.g., undergoes a photoreaction and generates a low molecular component, can be reduced. As a result, in a liquid crystal display device having the interlayer insulating film that uses the radiation-sensitive resin composition of the second embodiment of the invention, the bubbling defect can be reduced.

When containing the aforementioned acrylic polymer for the [A] polymer as the [A] component, the [C] compound is particularly capable of effectively exhibiting the function as the curing accelerator. Hence, the [C] compound is preferably added to the radiation-sensitive resin composition of the present embodiment for use in combination with the acrylic polymer as the [A] polymer.

Examples of the [C] compound include a compound represented by the following formula (C1), a compound represented by the following formula (C2), a tertiary amine compound, an amide compound, a thiol compound, a blocked isocyanate compound, and an imidazole ring-containing compound. Among them, the compound represented by the following formula (C1) and the compound represented by the following formula (C2) shown below are preferred.

(Compounds Represented by Formulae (C1) and (C2))

As described above, examples of the [C] compound include, as a suitable compound, at least one compound selected from the group consisting of the compounds represented by the following formulae (C1) and (C2). These compounds have an amino group and an electron-deficient group, and by adding such compounds to the radiation-sensitive resin composition, curing of the formed cured film can be accelerated. As a result, e.g., even under low-temperature curing conditions, a sufficient curing reaction is realized in the radiation-sensitive resin composition, and a cured film having high strength can be obtained. Accordingly, even if a light history is received in a step after the formation of the cured film, reaction of the unreacted component in the cured film or reaction of the cured film itself can be reduced. Furthermore, by applying, to a liquid crystal display device, the cured film obtained using the radiation-sensitive resin composition containing such [C] compound as the interlayer insulating film, a voltage holding ratio of the obtained liquid crystal display device can be further enhanced.

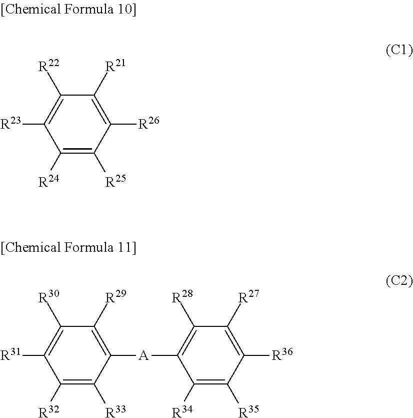

In the above formula (C1), R²¹ to R²⁶ are each independently a hydrogen atom, an electron withdrawing group or an amino group. However, at least one among R²¹ to R²⁶ is an electron withdrawing group and at least one among R²¹ to R²⁶ is an amino group, wherein some or all of the hydrogen atoms in the amino group may be replaced with alkyl groups having 1 to 6 carbons.

In the above formula (C2), R²⁷ to R³⁶ are each independently a hydrogen atom, an electron withdrawing group or an amino group. However, at least one among R²⁷ to R³⁶ is an amino group. In addition, in the amino group, some or all of the hydrogen atoms may be replaced with alkyl groups having 2 to 6 carbons. A is a single bond, a carbonyl group, a carbonyloxy group, a carbonyl methylene group, a sulfinyl group, a sulfonyl group, a methylene group or an alkylene group having 2 to 6 carbons. However, in the above methylene group and alkylene group, some or all of the hydrogen atoms may be replaced with cyano groups, halogen atoms or fluoroalkyl groups.

Examples of the electron withdrawing group represented by R²¹ to R²⁶ in the above formulae (C1) and (C2) include a halogen atom, a cyano group, a nitro group, a trifluoromethyl group, a carboxyl group, an acyl group, an alkylsulfonyl group, an alkyloxysulfonyl group, a dicyanovinyl group, a tricyanovinyl group, and a sulfonyl group, etc. Among them, nitro group, alkyloxysulfonyl group and trifluoromethyl group are preferred. In addition, examples of the group represented by A include a sulfonyl group, and a methylene group optionally replaced with a fluoroalkyl group.

The compounds represented by the above formulae (C1) and (C2) are preferably, 2,2-bis(4-aminophenyl)hexafluoropropane, 2,3-bis(4-aminophenyl)succinonitrile, 4,4′-diaminobenzophenone, 4,4′-diaminophenylbenzoate, 4,4′-diaminodiphenylsulfone, 1,4-diamino-2-chlorobenzene, 1,4-diamino-2-bromobenzene, 1,4-diamino-2-iodobenzene, 1,4-diamino-2-nitrobenzene, 1,4-diamino-2-trifluoromethylbenzene, 2,5-diaminobenzonitrile, 2,5-diaminoacetophenone, 2,5-diaminobenzoic acid, 2,2′-dichlorobenzidine, 2,2′-dibromobenzidine, 2,2′-diiodobenzidine, 2,2′-dinitrobenzidine, 2,2′-bis(trifluoromethyl)benzidine, ethyl 3-aminobenzenesulfonate, 3,5-bistrifluoromethyl-1,2-diaminobenzene, 4-aminonitrobenzene and N,N-dimethyl-4-nitroaniline, more preferably, 4,4′-diaminodiphenylsulfone, 2,2-bis(4-aminophenyl)hexafluoropropane, 2,2′-bis(trifluoromethyl)benzidine, ethyl 3-aminobenzenesulfonate, 3,5-bistrifluoromethyl-1,2-diaminobenzene, 4-aminonitrobenzene and N,N-dimethyl-4-nitroaniline.

The compounds represented by the above formulae (C1) and (C2) can be used alone or as a mixture of two or more thereof. The content of the compounds represented by the above formulae (C1) and (C2) is preferably 0.1 mass part to 20 mass parts, more preferably 0.2 mass part to 10 mass parts, with respect to 100 mass parts of the [A] component. By adjusting the content ratio of the compounds represented by the above formulae (C1) and (C2) to the above range, acceleration of curing of the cured film formed from the radiation-sensitive resin composition can be realized. Also, preservation stability of the radiation-sensitive resin composition is enhanced, and moreover, the voltage holding ratio of the liquid crystal display device having the obtained cured film as the interlayer insulating film can be maintained at a high level.

<[D] Polymerizable Unsaturated Compound>

The [D] polymerizable unsaturated compound as the [D] component of the radiation-sensitive resin composition of the second embodiment of the invention is an unsaturated compound that polymerizes due to irradiation with radiation in the presence of the aforementioned [B] photosensitizer. Such [D] polymerizable unsaturated monomer is not particularly limited. However, in view of good polymerizability and enhanced strength of the formed interlayer insulating film, a monofunctional, bifunctional, trifunctional or higher-functional (meth)acrylic ester is preferred.

Examples of the monofunctional (meth)acrylic ester include 2-hydroxyethyl(meth)acrylate, diethylene glycol monoethyl ether (meth)acrylate, (2-(meth)acryloyloxyethyl)(2-hydroxypropyl)phthalate, and carboxypolycaprolactone mono(meth)acrylate, etc. Examples of commercial products thereof include, as trade names, ARONIX® M-101, ARONIX® M-111, ARONIX® M-114 and ARONIX® M-5300 (the foregoing being made by Toagosei Company, Limited); KAYARAD® TC-110S and KAYARAD® TC-120S (the foregoing being made by Nippon Kayaku Co., Ltd.), and VISCOAT® 158 and VISCOAT® 2311 (the foregoing being made by Osaka Organic Chemical Industry Ltd.), etc.

Examples of the bifunctional (meth)acrylic ester include ethylene glycol di(meth)acrylate, propylene glycol di(meth)acrylate, diethylene glycol di(meth)acrylate, tetraethylene glycol diacrylate, tetraethylene glycol di(meth)acrylate, 1,6-hexanediol di(meth)acrylate, and 1,9-nonanediol di(meth)acrylate, etc. Examples of commercial products thereof include, as trade names, ARONIX® M-210, ARONIX® M-240 and ARONIX® M-6200 (the foregoing being made by Toagosei Company, Limited), KAYARAD® HDDA, KAYARAD® HX-220 and KAYARAD® R-604 (the foregoing being made by Nippon Kayaku Co., Ltd.), VISCOAT® 260, VISCOAT® 312 and VISCOAT® 335HP (the foregoing being made by Osaka Organic Chemical Industry Ltd.), and Light Acrylate® 1,9-NDA (made by Kyoeisha Chemical Co., Ltd.), etc.

Examples of the trifunctional or higher-functional (meth)acrylic ester include trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate; a mixture of dipentaerythritol penta(meth)acrylate and dipentaerythritol hexa(meth)acrylate; ethylene oxide-modified dipentaerythritol hexa(meth)acrylate, tri (2-(meth)acryloyloxyethyl)phosphate, succinic acid-modified pentaerythritol tri(meth)acrylate, succinic acid-modified dipentaerythritol penta(meth)acrylate, tripentaerythritol hepta(meth)acrylate, and tripentaerythritol octa(meth)acrylate; and a polyfunctional urethane acrylate-based compound obtained by reacting a compound having a linear alkylene group and an alicyclic structure and having two or more isocyanate groups with a compound having one or more hydroxy groups in a molecule and having three, four or five (meth)acryloyloxy groups, etc.

Examples of commercial products of the aforementioned trifunctional or higher-functional (meth)acrylic ester include, as trade names, ARONIX® M-309, ARONIX® M-400, ARONIX® M-405, ARONIX® M-450, ARONIX® M-7100, ARONIX® M-8030, ARONIX® M-8060 and ARONIX® TO-1450 (the foregoing being made by Toagosei Company, Limited), KAYARAD® TMPTA, KAYARAD® DPHA, KAYARAD® DPCA-20, KAYARAD® DPCA-30, KAYARAD® DPCA-60, KAYARAD® DPCA-120 and KAYARAD® DPEA-12 (the foregoing being made by Nippon Kayaku Co., Ltd.), VISCOAT® 295, VISCOAT® 300, VISCOAT® 360, VISCOAT® GPT, VISCOAT® 3PA and VISCOAT® 400 (the foregoing being made by Osaka Organic Chemical Industry Ltd.), or, as a commercial product containing the polyfunctional urethane acrylate-based compound, New Frontier® R-1150 (made by DKS Co. Ltd.), and KAYARAD® DPHA-40H (made by Nippon Kayaku Co., Ltd.), etc.

Among these [D] polymerizable unsaturated compounds, particularly the commercial products containing ω-carboxypolycaprolactone monoacrylate, 1,9-nonanediol dimethacrylate, trimethylolpropane triacrylate, pentaerythritol triacrylate, pentaerythritol tetraacrylate, ditrimethylolpropane tetraacrylate, ditrimethylolpropane tetramethacrylate, dipentaerythritol pentaacrylate, dipentaerythritol hexaacrylate;
a mixture of dipentaerythritol pentaacrylate and dipentaerythritol hexaacrylate;
a mixture of tripentaerythritol hepta(meth)acrylate and tripentaerythritol octa(meth)acrylate; and
ethylene oxide-modified dipentaerythritol hexaacrylate, the polyfunctional urethane acrylate-based compound, succinic acid-modified pentaerythritol triacrylate and succinic acid-modified dipentaerythritol pentaacrylate, etc. are preferred.

The [D] polymerizable unsaturated compound as described above can be used alone or as a mixture of two or more thereof.

A use ratio of the [D] polymerizable unsaturated compound in the radiation-sensitive resin composition of the present embodiment is preferably 30 mass parts to 250 mass parts, more preferably 50 mass parts to 200 mass parts, with respect to 100 mass parts of the [A] polymer. By adjusting the use ratio of the [D] polymerizable unsaturated compound to the above range, the interlayer insulating film can be formed having high resolution without causing a problem of development residues, which is preferred.

<Other Optional Components>

The radiation-sensitive resin composition of the present embodiment can contain, in addition to the [A] polymer and the [B] photosensitizer as essential components or the [C] compound and the [D] polymerizable unsaturated compound as optional components, other optional components.

The radiation-sensitive resin composition of the present embodiment can contain a surfactant, a preservation stabilizer, an adhesion aid, and a heat resistance improver, etc. as the other optional components if necessary without impairing the effects of the invention. Each of these optional components may be used alone or as a mixture of two or more thereof.

<Preparation of Radiation-Sensitive Resin Composition>

The radiation-sensitive resin composition of the second embodiment of the invention is prepared by mixing the [A] polymer and the [B] photosensitizer with, in addition to the [C] compound and the [D] polymerizable unsaturated compound, the aforementioned other optional components in a predetermined ratio if necessary without impairing the expected effects. The radiation-sensitive resin composition of the present embodiment is preferably dissolved in a suitable solvent to be used in a solution state.

The solvent used for preparing the radiation-sensitive resin composition may be one that is uniformly dissolved or dispersed in the [A] polymer and the [B] photosensitizer as well as in the [C] compound and the [D] polymerizable unsaturated compound that are contained if necessary and that does not react with each of the components. It is preferred that the solvent be uniformly dissolved or dispersed in the other optional components and do not react with each of the components.

Examples of the solvent used for preparing the radiation-sensitive resin composition of the present embodiment include an alcohol, a glycol ether, an ethylene glycol alkyl ether acetate, a diethylene glycol monoalkyl ether, a diethylene glycol dialkyl ether, a dipropylene glycol dialkyl ether, a propylene glycol monoalkyl ether, a propylene glycol alkyl ether acetate, a propylene glycol monoalkyl ether propionate, a ketone, and an ester, etc.

The content of the solvent in the radiation-sensitive resin composition of the present embodiment is not particularly limited, and is preferably an amount that results in a total concentration of all the components of the radiation-sensitive resin composition except the solvent of 5% by mass to 50% by mass, more preferably 10% by mass to 40% by mass, from the viewpoint of coating properties and stability, etc. of the obtained radiation-sensitive resin composition. When a solution of the radiation-sensitive resin composition is prepared, in fact, a concentration of the solid content (the components other than the solvent occupying the composition solution) according to the value of the desired film thickness of the cured film and so on is set within the above concentration range.

The thus prepared radiation-sensitive resin composition in a solution form is preferably used in formation of the cured film that serves as the interlayer insulating film after being filtered using a Millipore filter having a pore diameter of around 0.5 μm or the like.

### Third Embodiment

### <Interlayer Insulating Film>

The interlayer insulating film of the third embodiment of the invention is produced using the aforementioned radiation-sensitive resin composition of the second embodiment of the invention and is characterized by having excellent light transmission properties in which the transmittance for light having a wavelength of 310 nm reaches 70% or higher at a film thickness of 2 μm. That is, the interlayer insulating film of the third embodiment of the invention has a transmission of 70% or higher for light having a wavelength of 310 nm in terms of a film thickness of 2 μm.

That is, using the radiation-sensitive resin composition of the second embodiment of the invention, a cured film is formed having a transmittance reaching 70% or higher for light having a wavelength of 310 nm at a film thickness of 2 μm. The cured film is applicable to the liquid crystal display device of the first embodiment of the invention that has the array substrate and the color filter substrate paired with and disposed facing each other and the liquid crystal layer disposed between the two substrates, and constitutes the interlayer insulating film of the present embodiment.

In that case, e.g., the cured film using the radiation-sensitive resin composition of the second embodiment of the invention is laminated on the side of the array substrate in the liquid crystal display device of the first embodiment of the invention closer to the liquid crystal layer to constitute the interlayer insulating film of the present embodiment. More specifically, e.g., the cured film is disposed on the array substrate and underlying the pixel electrode, so that the array substrate, the interlayer insulating film and the pixel electrode are disposed in this order in the liquid crystal display device.

The film thickness of the interlayer insulating film of the third embodiment of the invention is preferably 1 μm to 5 μm, more preferably 2 μm to 3 μm. The interlayer insulating film 52 is capable of sufficiently exhibiting the insulation function and the planarization function by having a film thickness within the above range.

The interlayer insulating film of the present embodiment has patterning properties and excellent hardness, and further exhibits excellent adhesiveness with a substrate such as the array substrate or the like or with each structural member on the substrate.

As a result, the interlayer insulating film of the present embodiment is capable of realizing a higher pixel aperture ratio in the liquid crystal display device of the first embodiment of the invention that has the interlayer insulating film.

Also, as described above, the interlayer insulating film of the present embodiment has higher ultraviolet transmission properties as compared to the prior art, and particularly exhibits a high transmittance with respect to light having a wavelength of 310 nm.

Hence, in the liquid crystal display device of the first embodiment of the invention that has the interlayer insulating film of the present embodiment, the reaction of the interlayer insulating film caused by light, particularly the reaction caused by the more harmful light having a wavelength of 310 nm, can be reduced. As a result, in the liquid crystal display device of the first embodiment of the invention, the defect that the interlayer insulating film undergoes a photoreaction and generates a low molecular component to form bubbles in the pixel region can be reduced. That is, since the interlayer insulating film in the liquid crystal display device of the first embodiment of the invention is the interlayer insulating film of the present embodiment in which bubbling is easily suppressed, the bubbling defect conventionally regarded as a problem can be reduced.

The interlayer insulating film of the third embodiment of the invention can be produced by the later-described method for producing an interlayer insulating film of the fourth embodiment of the invention.

### Fourth Embodiment

### <Method for Producing Interlayer Insulating Film>

The method for producing an interlayer insulating film of the fourth embodiment of the invention is carried out using the aforementioned radiation-sensitive resin composition of the second embodiment of the invention, and is capable of producing, as a cured film patterned into a desired shape by the photolithography method and having high reliability, an interlayer insulating film having a transmittance of 70% or higher for light having a wavelength of 310 nm at a film thickness of 2 μm. In the method for producing an interlayer insulating film of the present embodiment, the radiation-sensitive resin composition of the second embodiment of the invention is used, and at least the following [1] to [4] steps are included so as to form on a substrate an interlayer insulating film having a desired shape:

[1] a step of forming a coating film of the radiation-sensitive resin composition of the present embodiment on a substrate (hereinafter sometimes “[1] step”);

[2] a step of irradiating at least a portion of the coating film of the radiation-sensitive resin composition formed in the [1] step with radiation (hereinafter sometimes “[2] step”);

[3] a step of developing the coating film irradiated with the radiation in the [2] step (hereinafter sometimes “[3] step”); and

[4] a step of heating the coating film developed in the [3] step (hereinafter sometimes “[4] step”).

The [1] to [4] steps are explained below.

([1] Step)

In the method for producing an interlayer insulating film of the present embodiment, in the [1] step, the coating film of the radiation-sensitive resin composition of the second embodiment of the invention is formed on a substrate. Examples of a material of this substrate include glass such as soda-lime glass or non-alkali glass, etc., silicon, polyethylene terephthalate, polybutylene terephthalate, polyethersulfone, a polycarbonate, an aromatic polyamide, a polyamide-imide, and a polyimide, etc. Furthermore, the substrate can also be subjected to, in addition to washing or pre-annealing, a proper pretreatment in advance, such as a chemical treatment using a silane coupling agent, a plasma treatment, ion plating, sputtering, a vapor phase reaction method, and vacuum vapor deposition, etc. as desired.

In addition, when the interlayer insulating film produced by the method for producing an interlayer insulating film of the fourth embodiment of the invention is a liquid crystal display device of active matrix type like the liquid crystal display device of the first embodiment of the invention, as the substrate, a substrate on which a gate wiring and a signal wiring are arranged in a matrix (lattice) and a switching element such as a TFT or the like is provided at each intersection between the gate wiring and the signal wiring can be used

A method for coating the radiation-sensitive resin composition of the second embodiment of the invention is not particularly limited. For example, a proper method such as a spraying method, a roll coating method, a rotary coating method (sometimes also called a spin coating method or a spinner method), a slit coating method (sometimes also called a slit die coating method), a bar coating method, and an inkjet coating method or the like can be adopted. Among them, in view of capability to form a film having a uniform thickness, the spin coating method or the slit coating method is preferred.

When a coating film of the radiation-sensitive resin composition is formed by a coating method, after the radiation-sensitive resin composition is coated on the substrate, it is preferred to evaporate the solvent by heating (prebaking) the coated surface, and the coating film can be formed.

The prebaking conditions vary depending on types and blending proportions of components that compose the radiation-sensitive resin composition. The temperature is preferably 70° C. to 120° C., and the time is preferably around 1 minute to 15 minutes. The film thickness of the coating film after prebaking is preferably 0.5 μm to 10 μm, more preferably around 1 μm to 7 μm.

([2] Step)

Next, at least a portion of the coating film formed on the substrate in the [1] step is irradiated (hereinafter also “exposed”) with radiation. At this moment, to form the interlayer insulating film in desired position and shape, and, e.g., to form the interlayer insulating film having a desired contact hole, the irradiation on a portion of the coating film with radiation can be performed through, e.g., a photomask having a predetermined pattern.

Examples of the radiation used for the exposure include a visible ray, an ultraviolet ray, and a far ultraviolet ray, etc. Among them, the radiation having a wavelength ranging from 250 nm to 550 nm is preferred, and the radiation containing an ultraviolet ray of 365 nm is more preferred.

A radiation irradiation amount (also referred to as an exposure amount) can be set to, as a value of strength of the irradiated radiation at a wavelength of 365 nm as measured by an illuminometer (OAI model 356 made by Optical Associates Inc.), 10 J/m² to 10,000 J/m², preferably 100 J/m² to 5000 J/m², and more preferably 200 J/m² to 3000 J/m².

([3] Step)

In the [3] step, by developing the exposed coating film obtained in the [2] step, an unwanted portion (the portion irradiated with the radiation if the coating film of the radiation-sensitive resin composition is of positive type; or the portion not irradiated with the radiation if the coating film is of negative type) is removed so as to form an exposed coating film having a predetermined pattern.

The developer used in the development step is preferably an alkali developer composed of an aqueous solution of an alkali (basic compound). Examples of the alkali include an inorganic alkali such as sodium hydroxide, potassium hydroxide, sodium carbonate, sodium silicate, sodium metasilicate, and ammonia, etc.; and a quaternary ammonium salt such as tetramethylammonium hydroxide and tetraethyl ammonium hydroxide, etc.

In addition, a suitable amount of a water-soluble organic solvent such as methanol, ethanol or the like or a surfactant can also be added to such alkali developer for use. The concentration of the alkali in the alkali developer can preferably be set to 0.1% to 5% by mass from the viewpoint of obtaining suitable developability. The development method can be a proper method such as a puddle method, a dipping method, a shaking-immersion method, and a shower method, etc. The development time varies depending on the composition of the radiation-sensitive resin composition of the second embodiment of the invention, and is preferably around 10 seconds to 180 seconds. Subsequently to such development treatment, e.g., a running water wash is performed for 30 seconds to 90 seconds, followed by, e.g., air drying using compressed air or compressed nitrogen, thereby forming a desired pattern in the exposed coating film.

([4] Step)

In the [4] step, the exposed coating film having a predetermined pattern that is obtained in the [3] step is heated (also “post-baked”) by a suitable heating apparatus such as a hot plate, an oven or the like. Accordingly, the exposed coating film having a predetermined pattern can be cured, and the interlayer insulating film as a cured film is obtained.

The temperature of the heating in the [4] step can be set to, e.g., 80° C. to 280° C. The heating time is preferably set to, e.g., 5 minutes to 30 minutes on a hot plate, or 30 minutes to 180 minutes in an oven.

According to the radiation-sensitive resin composition of the second embodiment of the invention, it is possible to set the curing temperature to 80° C. to 200° C. or lower. Furthermore, when the radiation-sensitive resin composition of the second embodiment of the invention contains the aforementioned [C] compound, an interlayer insulating film having sufficient properties can be obtained even at a temperature of 180° C. or less, which is more suitable for formation on a resin substrate.

According to the above method for producing an interlayer insulating film of the fourth embodiment of the invention, the interlayer insulating film can be formed on the substrate. The interlayer insulating film produced by the method for producing an interlayer insulating film of the present embodiment has higher ultraviolet transmission properties as compared to the prior art, and particularly exhibits excellent transmission properties in which the transmittance for light having a wavelength of 310 nm reaches 70% or higher at a film thickness of 2 μm.

Hence, as described above, the interlayer insulating film produced by the method for producing an interlayer insulating film of the fourth embodiment of the invention can be suitably used for constituting the liquid crystal display device of the first embodiment of the invention that has the array substrate and the color filter substrate paired with and disposed facing each other and the liquid crystal layer disposed sandwiched between the two substrates.

For example, as described above, the liquid crystal display device of the first embodiment of the invention can be in the VA mode using the PSA technique. In that case, the liquid crystal display device can be manufactured by a manufacturing method including a step of irradiating light onto the polymerizable liquid crystal composition sandwiched between the array substrate and the color filter substrate while a voltage is applied to the polymerizable liquid crystal composition. At this moment, the array substrate that constitutes the liquid crystal display device can be constituted using the interlayer insulating film produced by the method for producing an interlayer insulating film of the present embodiment.

Hence, in the liquid crystal display device of the first embodiment of the invention, the array substrate can include the interlayer insulating film produced by the method for producing an interlayer insulating film of the present embodiment, wherein the interlayer insulating film is capable of exhibiting excellent transmission properties in which the transmittance for light having a wavelength of 310 nm reaches 70% or higher at a film thickness of 2 μm.

Accordingly, in the liquid crystal display device of the first embodiment of the invention, the reaction of the interlayer insulating film caused by light, particularly the reaction caused by the more harmful light having a wavelength of 310 nm, can be reduced. As a result, in the liquid crystal display device, the defect that the interlayer insulating film undergoes a photoreaction and generates a low molecular component to form bubbles in the pixel region can be reduced. That is, in the liquid crystal display device of the first embodiment of the invention including the interlayer insulating film produced by the method for producing an interlayer insulating film of the fourth embodiment of the invention, since bubbling in the interlayer insulating film is easily suppressed, the bubbling defect conventionally regarded as a problem can be reduced.

### EXAMPLES

The embodiments of the invention are hereinafter explained in more detail based on examples. However, the invention should not be restrictively interpreted by the examples.

<Synthesis of [A] Polymer>

In the present examples, a polymer (A-1), a polymer (A-2), a polymer (A-3) and a polymer (A-4) were used as examples of the aforementioned [A] polymer. Synthesis examples of the polymers (A-1) to (A-4) and a synthesis example of a polymer (a-1) serving as a comparative example are shown below.

### Synthesis Example 1

### [Acrylic Polymer: Synthesis of Polymer (A-1)]

8 mass parts of 2,2′-azobis(2,4-dimethylvaleronitrile) and 220 mass parts of diethylene glycol methyl ethyl ether were placed in a flask equipped with a cooling pipe and a stirrer. Next, 15 mass parts of methacrylic acid, 40 mass parts of 3,4-epoxycyclohexyl methacrylate, 20 mass parts of styrene, 15 mass parts of tetrahydrofurfuryl methacrylate, and 10 mass parts of n-lauryl methacrylate were placed therein, and a nitrogen purge was performed. Then, the resultant solution was gently stirred while its temperature was raised to 70° C. By maintaining the solution at this temperature for 5 hours to perform polymerization, a solution containing an acrylic polymer (A-1) as a copolymer was obtained. The acrylic polymer (A-1) as a copolymer had an Mw of 8000.

### Synthesis Example 2

### [Acrylic Polymer: Synthesis of Polymer (A-2)]

8 mass parts of 2,2′-azobis(2,4-dimethylvaleronitrile) and 220 mass parts of diethylene glycol methyl ethyl ether were placed in a flask equipped with a cooling pipe and a stirrer. Next, 40 mass parts of glycidyl methacrylate, 20 mass parts of 4-(α-hydroxyhexafluoroisopropyl)styrene, 10 mass parts of styrene, and 30 mass parts of N-cyclohexylmaleimide were placed therein, and a nitrogen purge was performed. Then, the resultant solution was gently stirred while its temperature was raised to 70° C. By maintaining the solution at this temperature for 5 hours to perform polymerization, a solution containing an acrylic polymer (A-2) as a copolymer was obtained. The acrylic polymer (A-2) as a copolymer had an Mw of 8000.

### Synthesis Example 3

### [Polyimide: Synthesis of Polymer (A-3)]

Under a dry nitrogen gas stream, 29.30 g (0.08 mol) of bis(3-amino-4-hydroxyphenyl)hexafluoropropane (made by Central Glass Co., Ltd.), 1.24 g (0.005 mol) of 1,3-bis(3-aminopropyl)tetramethyldisiloxane, and 3.27 g (0.03 mol) of 3-aminophenol (made by Tokyo Chemical Industry Co., Ltd.) as an end capping agent were dissolved in 80 g of N-methyl-2-pyrrolidone (hereinafter NMP). Here, 31.2 g (0.1 mol) of bis(3,4-dicarboxyphenyl)ether dianhydride (made by Manac Incorporated) was added together with 20 g of NMP, and the resultant was reacted at 20° C. for 1 hour, followed by reaction at 50° C. for 4 hours. After that, 15 g xylene was added, and the resultant was stirred at 150° C. for 5 hours while water was boiled together with xylene. After the stirring was completed, the reaction solution was put into 3 L of water to obtain white precipitates. The precipitates were collected by filtration, washed three times with water, and then dried for 20 hours in a vacuum dryer at 80° C. Thus, a polyimide (A-3) as a polymer having a structure represented by the following formula was obtained.

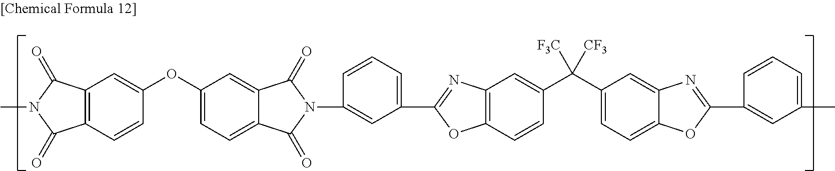

### Synthesis Example 4

### [Synthesis of Polysiloxane (Polymer (A-4))]

20 mass parts of propylene glycol monomethyl ether were placed into a vessel equipped with a stirrer. Next, 70 mass parts of methyltrimethoxysilane and 30 mass parts of tolyltrimethoxysilane were placed therein, and the resultant solution was heated to 60° C. After the temperature of the solution reached 60° C., 0.15 mass part of phosphoric acid and 19 mass parts of ion-exchanged water were placed therein, and the solution was heated to 75° C. and was maintained at this temperature for 4 hours. Further, by adjusting the temperature of the solution to 40° C. and performing evaporation while maintaining this temperature, the ion-exchanged water and methanol generated by hydrolysis-condensation were removed. According to the above, a polysiloxane (A-4) as a siloxane polymer being a hydrolysis-condensation product was obtained. The polysiloxane (A-4) had an Mw of 5000.

### Comparative Synthesis Example 1

[Acrylic Polymer: Synthesis of Polymer (a-1)]

8 mass parts of 2,2′-azobis(2,4-dimethylvaleronitrile) and 220 mass parts of diethylene glycol methyl ethyl ether were placed in a flask equipped with a cooling pipe and a stirrer. Next, 15 mass parts of methacrylic acid, 40 mass parts of glycidyl methacrylate, 20 mass parts of α-methyl-p-hydroxystyrene, 10 mass parts of styrene, 15 mass parts of N-cyclohexylmaleimide and 10 mass parts of n-lauryl methacrylate were placed therein, and a nitrogen purge was performed. Then, the resultant solution was gently stirred while its temperature was raised to 70° C. By maintaining the solution at this temperature for 5 hours to perform polymerization, a solution containing an acrylic polymer (a-1) as a copolymer was obtained. The acrylic polymer (a-1) as a copolymer had an Mw of 8000.

<Preparation of Radiation-Sensitive Resin Composition>

### Examples 1 to 10 and Comparative Examples 1 to 2

Each polymer solution (in an amount corresponding to 100 mass parts (solid content) of the [A] polymer) containing the [A] polymer (the polymers (A-1) to (A-4) and the polymer (a-1)) according to the aforementioned synthesis examples and comparative synthesis example was mixed with the [B] photosensitizer, further mixed with the [C] compound and the [D] polymerizable unsaturated compound if necessary, and dissolved in diethylene glycol methyl ethyl ether so that the concentration of the solid content reached 30% by mass. Then, the resultant was filtered using a membrane filter having a pore diameter of 0.2 μm, so as to prepare a solution of each radiation-sensitive resin composition ((S-1) to (S-10) and (s-1) to (s-2)) in Examples 1 to 10 and Comparative Examples 1 to 2 having the compositions shown in Table 1. Moreover, in Table 1, “-” means that the corresponding component was not blended in.

The [A] polymer, the [B] photosensitizer, the [C] compound and the [D] polymerizable unsaturated compound used for preparing the radiation-sensitive resin compositions ((S-1) to (S-10)) in Examples 1 to 10 and the radiation-sensitive resin compositions ((s-1) to (s-2)) in Comparative Examples 1 to 2 are as follows.

<[A] Polymer>

A-1: Polymer (A-1) synthesized in Synthesis Example 1

A-2: Polymer (A-2) synthesized in Synthesis Example 2

A-3: Polymer (A-3) synthesized in Synthesis Example 3

A-4: Polymer (A-4) synthesized in Synthesis Example 4

a-1: Polymer (a-1) synthesized in Comparative Synthesis Example 1

<[B] Photosensitizer>

B-1: 1,2-octanedione 1-[4-(phenylthio)-2-(O-benzoyloxime)] (Irgacure® OX01 made by BASF)

B-2: Condensate of 4,4′-[1-[4-[1-[4-hydroxyphenyl]-1-methylethyl]phenyl]ethylidene]bisphenol (1.0 mol) and 1,2-naphthoquinonediazide-5-sulfonic acid chloride (2.0 mol)

B-3: 2-nitrobenzylcyclohexyl carbamate

B-4: (5-propylsulfonyloxyimino-5H-thiophene-2-ylidene)-(2-methylphenyl)acetonitrile

<[C] Compound>

C-1: 4,4-diaminodiphenylsulfone

<[D] Polymerizable Unsaturated Compound>

D-1: Mixture of dipentaerythritol pentaacrylate and dipentaerythritol hexaacrylate (KAYARAD® DPHA, made by Nippon Kayaku Co., Ltd.)

TABLE 1

| | | | | | | | | [D] | |
|---|---|---|---|---|---|---|---|---|---|
| | | | | [B] | | | | Polymerizable | |
| | Radiation- | [A] | | Photosen- | | [C] | | unsaturated | |
| | sensitive | Polymer | | sitizer | | Compound | | compound | |
| | resin | | Mass | | Mass | | Mass | | Mass |
| | composition | Type | part | Type | part | Type | part | Type | part |
| Example 1 | S-1 | A-1 | 100 | B-2 | 30 | — | — | — | — |
| Example 2 | S-2 | A-2 | 100 | B-2 | 30 | — | — | — | — |
| Example 3 | S-3 | A-3 | 100 | B-2 | 30 | — | — | — | — |
| Example 4 | S-4 | A-4 | 100 | B-2 | 15 | — | — | — | — |
| Example 5 | S-5 | A-1 | 100 | B-1 | 20 | C-1 | 10 | D-1 | 100 |
| Example 6 | S-6 | A-2 | 100 | B-1 | 20 | — | — | D-1 | 100 |
| Example 7 | S-7 | A-3 | 100 | B-1 | 20 | — | — | D-1 | 100 |
| Example 8 | S-8 | A-4 | 100 | B-1 | 20 | — | — | D-1 | 100 |
| Example 9 | S-9 | A-1 | 100 | B-1 | 30 | — | — | D-1 | 50 |
| Example 10 | S-10 | A-1 | 100 | B-1 | 30 | C-1 | 10 | D-1 | 50 |
| Comparative | s-1 | a-1 | 100 | B-1 | 20 | — | — | D-1 | 100 |
| Example 1 | | | | | | | | | |
| Comparative | s-2 | a-1 | 100 | B-2 | 30 | — | — | — | — |
| Example 2 | | | | | | | | | |

<Production and Evaluation of Cured Film>

### Example 11

### [Evaluation of Transmittance]

Each radiation-sensitive resin composition ((S-1) to (S-10) and (s-1) to (s-2)) prepared in Examples 1 to 10 and Comparative Examples 1 to 2 was coated onto a glass substrate (“Corning 7059” (made by Corning Incorporated)) using a spinner. Then, the resultant was prebaked on a hot plate at 90° C. for 2 minutes, so as to form a coating film having a film thickness of 2.0 μm. Next, exposure was performed on each coating film using an exposure machine PLA-501F (ultra-high-pressure mercury lamp) made by Canon Inc. After that, each glass substrate having the coating film formed thereon was heated on a hot plate at 230° C. for 45 minutes, so as to produce a cured film.

Next, with respect to each obtained cured film on the glass substrate, the transmittance was measured using an ultraviolet and visible spectrophotometer (V-630, made by JASCO Corporation). In regard to evaluation results, the transmittance of the each cured film at a wavelength of 310 nm is shown in terms of “transmittance (%)” in Table 2, together with the types of the radiation-sensitive resin compositions used.

<Manufacture of Liquid Crystal Panel and Evaluation of VHR>

### Example 12

### [Evaluation of Voltage Holding Ratio (VHR)]

Each radiation-sensitive resin composition ((S-1) to (S-10) and (s-1) to (s-2)) prepared in Examples 1 to 10 and Comparative Examples 1 to 2 was spin-coated onto a glass substrate having a SiO₂ film formed on its surface to prevent elution of sodium ions and having an ITO electrode vapor-deposited in a predetermined shape. Then, the resultant was subjected to prebaking in a clean oven at 90° C. for 10 minutes, so as to form a coating film having a film thickness of 2.0 μm on the glass substrate. Next, exposure was performed on an entire surface of each coating film at an exposure amount of 500 J/m² using an exposure machine PLA-501F (ultra-high-pressure mercury lamp) made by Canon Inc. without through a photomask. After that, each coating film was subjected to post-baking at 230° C. for 30 minutes to be cured, so as to produce a cured film.

Next, each of the glass substrates equipped with the ITO electrode and having the aforementioned cured film formed thereon and a glass substrate having only an ITO electrode vapor-deposited in a predetermined shape were bonded together using a sealing agent having glass beads of 5.5 μm mixed in, so as to manufacture an empty panel. Next, a nematic liquid crystal having negative dielectric anisotropy was put into each empty panel, so as to manufacture a liquid crystal panel.

Next, ultraviolet irradiation was performed on an entire surface of each liquid crystal panel as manufactured above at an irradiation amount of 1000 J/m² from the side of the glass substrate equipped with the ITO electrode and having the cured film formed thereon, using an exposure machine PLA-501F (ultra-high-pressure mercury lamp) made by Canon Inc.

Next, each ultraviolet-irradiated liquid crystal panel was placed in a constant-temperature bath, and a voltage of 5 V was applied thereto at 70° C. for an application time of 60 μs in a span of 167 ms. Then, the voltage holding ratio after 167 ms from termination of the application was measured using “VHR-1” made by Toyo Corporation. A numerical value at this moment was used as the voltage holding ratio (VHR) of the each liquid crystal panel. As a result of evaluation, when the VHR was 93% or more, the liquid crystal panel was evaluated to have good voltage holding properties; when the VHR was 96% or more, the liquid crystal panel was evaluated to have the best voltage holding properties. The evaluation results are shown in Table 2 together with the types of the radiation-sensitive resin compositions used.

<Manufacture of Liquid Crystal Display Device and Evaluation of Bubbling>

### Example 13

### [Evaluation of Bubbling]

In the present example, a VA-mode color liquid crystal display device of active matrix type having the same structure as that of the liquid crystal display device 1 as an example of the first embodiment of the invention in FIG. 1 described above was manufactured by properly employing a well-known method.

First of all, manufacture of an array substrate that constitutes the liquid crystal display device was carried out. To allow the manufactured array substrate to have the same TFT as the TFT 29 in FIG. 1 described above, first, in accordance with a well-known method, a TFT, electrode or wiring, etc. having a semiconductor layer composed of p-Si, and an inorganic insulating film composed of SiN were disposed on an insulating glass substrate composed of non-alkali glass, so as to prepare a substrate having a TFT. Accordingly, in the present example, the TFT of the array substrate is formed in accordance with a well-known method, such as by repeating ordinary semiconductor film formation and well-known insulating layer formation, etc., and etching by a photolithography method, on the glass substrate.

Next, the radiation-sensitive resin composition (S-1) prepared in Example 1 was coated onto the prepared substrate having the TFT, using a slit die coater. Next, the resultant was prebaked on a hot plate at 90° C. for 100 seconds to evaporate the organic solvent, etc., so as to form a coating film.

Next, a UV (ultraviolet) exposure machine (Deep-UV exposure machine TME-400PRJ, made by TOPCON) was used to irradiate UV light of 100 mJ through a pattern mask capable of forming a predetermined pattern. After that, a development treatment was performed at 25° C. for 100 seconds by a puddle method using a tetramethylammonium hydroxide aqueous solution (developer) having a concentration of 2.38% by mass. After the development treatment, a running water wash of the coating film was performed for 1 minute using ultrapure water, followed by drying to form a patterned coating film on the substrate. Then, the resultant was heated (post-baked) in an oven at 230° C. for 30 minutes to be cured, so as to form in a cured film on the substrate, and the cured film was used as an interlayer insulating film. The interlayer insulating film on the substrate was patterned to form a contact hole.

Next, a film composed of ITO was formed on the interlayer insulating film by employing a sputtering method, followed by patterning by a photolithography method, so as to form a pixel electrode. The formed pixel electrode was connected to the TFT through the contact hole.

Next, a color filter substrate manufactured by a well-known method was prepared. In this color filter substrate, a red color filter, a green color filter and a blue color filter, and a black matrix were arranged in a lattice on a transparent glass substrate to form a color filter, wherein on the color filter, an insulating film serving as a planarization layer of the color filter was formed. Furthermore, a transparent common electrode composed of ITO was formed on the insulating film.

Next, on the surface of the manufactured array substrate where the TFT is disposed and the surface of the manufactured color filter substrate where the color filter is disposed, respectively, a liquid crystal aligning agent (trade name: JALS2095-S2, made by JSR Corporation) was coated using a spinner, and the resultant was heated at 80° C. for 1 minute and then at 180° C. for 1 hour, thereby forming an alignment film having a film thickness of 60 nm, so as to manufacture an array substrate equipped with an alignment film, and a color filter substrate equipped with an alignment film.

Next, an ultraviolet-curable seal material was coated on an outer periphery of a pixel region of each substrate. Then, a polymerizable liquid crystal composition prepared by adding a polymerizable component having photopolymerizability to a nematic liquid crystal having negative dielectric anisotropy was dripped on the inside of the seal material using a dispenser.

After that, in a vacuum, the color filter substrate was bonded to the array substrate having the polymerizable liquid crystal composition dripped thereon. Next, the seal material was irradiated with UV (ultraviolet) light while a UV (ultraviolet) light source was moved along the region coated with the seal material, and the seal material was cured. In this manner, the polymerizable liquid crystal composition was sealed between the array substrate and the color filter substrate facing each other, so as to form a layer of the polymerizable liquid crystal composition.

Next, while a voltage that turns on the TFT of the array substrate was applied to a gate electrode of the TFT, an AC voltage was applied between a source electrode of the TFT and the common electrode on the color filter substrate, so as to tilt-align the liquid crystal in the layer of the polymerizable liquid crystal composition. Next, while the liquid crystal remained tilt-aligned, ultraviolet light was irradiated on the layer of the polymerizable liquid crystal composition from the side of the array substrate using an ultra-high-pressure mercury lamp, and a liquid crystal layer was formed in which the liquid crystal formed a pretilt angle in a predetermined direction so as to be approximately vertically aligned. In the above manner, the VA-mode color liquid crystal display device was manufactured.

Next, an impact was given to the manufactured liquid crystal display device at high temperature (80° C.), and whether or not bubbling occurred in pixels was confirmed. The impact on the liquid crystal display device was given by dropping a pachinko ball from 30 cm above the liquid crystal display device. As a result of the application of the impact, in the pixels of the liquid crystal display device, the cases where no bubbling occurred at all and where bubbling occurred but the density of bubbles was small were evaluated as good, and the case where the density of bubbles was large was evaluated as bad. The evaluation results in which “good” is indicated by “∘” and “bad” is indicated by “×” are shown in Table 2 together with the types of the radiation-sensitive resin compositions used.

Next, VA-mode color liquid crystal display devices were respectively manufactured by the same method as above except that the type of the radiation-sensitive resin composition used in the manufacture differed, and the radiation-sensitive resin compositions ((S-2) to (S-10) and (s-1) to (s-2)) prepared in Examples 2 to 10 and Comparative Examples 1 to 2 were respectively used.

After that, for each of the liquid crystal display devices manufactured by the same method as above, whether or not bubbling occurred in the pixels as a result of the application of the impact was confirmed and an evaluation thereof was carried out. The evaluation results are shown in Table 2 together with the types of the radiation-sensitive resin compositions used.

TABLE 2

| Radiation-sensitive | | Example 11 | Example 12 | Example 13 |
|---|---|---|---|---|
| resin composition | | Transmittance | VHR | Evaluation of |
| Examples | Type | % | % | bubbling |
| Example 1 | S-1 | 73 | 94.1 | ∘ |
| Example 2 | S-2 | 81 | 99.3 | ∘ |
| Example 3 | S-3 | 75 | 95.9 | ∘ |
| Example 4 | S-4 | 92 | 99.4 | ∘ |
| Example 5 | S-5 | 74 | 93.9 | ∘ |
| Example 6 | S-6 | 78 | 97.8 | ∘ |
| Example 7 | S-7 | 77 | 95.2 | ∘ |
| Example 8 | S-8 | 94 | 98.3 | ∘ |
| Example 9 | S-9 | 95 | 95.5 | ∘ |
| Example 10 | S-10 | 96 | 95.9 | ∘ |
| Comparative | s-1 | 64 | 90.9 | x |
| Example 1 | | | | |
| Comparative | s-2 | 66 | 91.7 | x |
| Example 2 | | | | |

In the liquid crystal display devices manufactured using the radiation-sensitive resin compositions ((S-1) to (S-10)) prepared in Examples 1 to 10, with respect to the application of the impact, no bubbling occurred or bubbling was suppressed. On the other hand, in the liquid crystal display devices manufactured using the radiation-sensitive resin compositions ((s-1) to (s-2)) prepared in Comparative Examples 1 to 2, with respect to the application of the impact, noticeable bubbling was seen.

Moreover, the invention is not limited to the above embodiments, but can be carried out by making various modifications without departing from the gist of the invention.

### INDUSTRIAL APPLICABILITY

The liquid crystal display device of the invention includes an interlayer insulating film formed using the radiation-sensitive resin composition of the invention, is capable of high-quality display, and is also capable of exhibiting high reliability. Accordingly, the liquid crystal display device of the invention is suitable for use in, in addition to large liquid crystal TVs, display devices of portable information devices such as smartphones and so on that have recently been strongly desired to have lower power consumption and higher image quality.

### DESCRIPTION OF REFERENCE NUMERALS

1: Liquid crystal display device

10: Liquid crystal layer

15 and 115: Array substrate

21, 91, and 121: Substrate

22 and 122: Base coat film

23 and 123: Semiconductor layer

24 and 124: Gate insulating film

25 and 125: Gate electrode

29 and 129: TFT

31f and 31g: Contact hole

34 and 134: Source electrode

35 and 135: Drain electrode

36: Pixel electrode

37 and 95: Alignment film

41 and 141: Inorganic insulating film

52 and 152: Interlayer insulating film

61: First wiring layer

90: Color filter substrate

92: Black matrix

93: Color filter

94: Common electrode

1. A liquid crystal display device, having
a pair of substrates disposed facing each other;
a liquid crystal layer formed from a polymerizable liquid crystal composition and disposed between the substrates; and
an interlayer insulating film laminated on a side of at least one of the substrates closer to the liquid crystal layer, wherein
the interlayer insulating film has a transmittance of 70% or higher for light having a wavelength of 310 nm at a film thickness of 2 μm.

2. The liquid crystal display device according to claim 1, wherein the interlayer insulating film has a film thickness of 1 μm to 5 μm.

3. The liquid crystal display device according to claim 1, wherein the substrate has a pixel electrode, and the substrate, the interlayer insulating film and the pixel electrode are provided in this order.

4. The liquid crystal display device according to claim 1, wherein a liquid crystal alignment layer having a vertical alignment property is provided on a surface of the side of the substrate closer to the liquid crystal layer, so as to constitute a vertical alignment (VA) mode liquid crystal display device.

5. The liquid crystal display device according to claim 1, wherein the interlayer insulating film is formed using a radiation-sensitive resin composition containing [A] a polymer and [B] a photosensitizer.

6. The liquid crystal display device according to claim 1, wherein the polymerizable liquid crystal composition has photopolymerizability or thermal polymerizability.

7. A radiation-sensitive resin composition, containing
[A] a polymer; and
[B] a photosensitizer, wherein
the radiation-sensitive resin composition is used for forming the interlayer insulating film of the liquid crystal display device according to claim 1.

8. The radiation-sensitive resin composition according to claim 7, wherein the [A] polymer has at least one group selected from the group consisting of an epoxy group, a (meth)acryloyl group and a vinyl group.

9. The radiation-sensitive resin composition according to claim 7, wherein the [B] photosensitizer is at least one selected from the group consisting of a photo-radical polymerization initiator, a photoacid generator and a photobase generator.

10. An interlayer insulating film, formed using the radiation-sensitive resin composition according to claim 7, having a transmittance of 70% or higher for light having a wavelength of 310 nm at a film thickness of 2 μm, and used in a liquid crystal display device.

11. A method for producing an interlayer insulating film, comprising
[1] a step of forming a coating film of the radiation-sensitive resin composition according to claim 7 on a substrate;
[2] a step of irradiating at least a portion of the coating film formed in step [1] with radiation;
[3] a step of developing the coating film irradiated with the radiation in step [2]; and
[4] a step of heating the coating film developed in step [3], wherein
the method produces an interlayer insulating film of a liquid crystal display device, the interlayer insulating film having a transmittance of 70% or higher for light having a wavelength of 310 nm at a film thickness of 2 μm.

12. A method for manufacturing a liquid crystal display device, comprising a step of irradiating light onto a polymerizable liquid crystal composition sandwiched between a pair of substrates while a voltage is applied to the polymerizable liquid crystal composition, wherein
at least one of the pair of substrates has an interlayer insulating film produced by the method according to claim 11.
